(19) United States
(12) Patent Application Publication
(10) Pub. No.: US 2026/0364560 A1
(43) Pub. Date: Nov. 19, 2026

(54) PROCESS FOR CONTINUOUS PRODUCTION OF AQUEOUS POLYURETHANE-POLYUREA DISPERSIONS AND AQUEOUS POLYURETHANE-POLYUREA DISPERSIONS

(71) Applicant: BASF COATINGS GMBH, Muenster (DE)

(72) Inventors: Hardy REUTER, Muenster (DE); Juergen BAUER, Glattbach (DE)

(21) Appl. No.: 19/154,402

(22) PCT Filed: Jan. 23, 2024
(86) PCT No.: PCT/EP2024/051491

§ 371 Date: Aug. 7, 2025

(30) Foreign Application Priority Data
Feb. 21, 2023 (EP) 23157766.9

(51) Int. Cl. B01J 13/00; B05D 7/00; C08G 18/08; C08G 18/10; C08G 18/32; C08G 18/42; C08G 18/75; C08L 75/04; C09D 175/04

(52) U.S. Cl. CPC B01J 13/0026; B05D 7/572; C08G 18/0895; C08G 18/10; C08G 18/3228; C08G 18/4233; C08G 18/758; C08L 75/04; C09D 175/04; B05D 2401/20; B05D 2503/00; C08G 2150/00

(57) ABSTRACT

Disclosed herein are an aqueous polyurethane-polyurea dispersion and a process for continuous production of the aqueous polyurethane-polyurea dispersion including the use of a high shear dispersion device including a specific rotor/stator unit.

The present invention relates to an aqueous polyurea-polyurethane dispersion and also to a process for continuous production of an aqueous polyurethane-polyurea dispersion. The dispersions have excellent applicability in coating composition, specifically in aqueous pigmented coating compositions, and provide for an improved yellowing behavior. Concurrently, the dispersions are producible with very low content of organic solvents without the need of a step of removing such solvent via distillation. Also, the polymer particles comprised in the dispersion have a very low particle size, leading to an excellent storage stability.

### PRIOR ART

Aqueous dispersions of polyurethane and polyurethane-polyurea polymers are well-known in the art. They find broad applicability in versatile industrial branches like, for example, the coating industry. The polymers, in particular, are used as binder resins in coating materials and decisively influence the properties and quality level of these materials.

The prior art describes versatile polyurethane and polyurethane-polyurea polymers and its application in, for example, automotive basecoat materials. For being applicable in such applications and fields, an optimal and stable dispersive character with low particle sizes of the dispersed polymer particles is required.

For example, WO 2014/007915 A1 discloses a method for producing a multicoat automobile finish, using an aqueous basecoat material which comprises an aqueous dispersion of a polyurethane-polyurea resin produced via batch production. The use of the basecoat material produces positive effects on the optical properties, in particular a minimizing of gel specks.

WO 2016/091539 A1 describes high-quality aqueous polyurethane-polyurea dispersion containing microgel particles and its production via batch procedure. The dispersions are applied as binder resins in automotive basecoat compositions and contribute to improvement of properties like stability against pinholes and pops. During production of the dispersions, comparably high amounts of organic solvents need to be applied, ultimately leading to the requirement of having these distilled off in order to obtain an aqueous dispersion with low content of such organic solvents. While WO 2016/091539 A1 generally discloses in form of an exhaustive list also alkali metal hydroxides as neutralizing agents, only amine-based organic bases are in focus and actually applied. The addition of the neutralizing agent always occurs in organic-based phase, i.e. before or during the manufacture of a respective polyurethane prepolymer or directly thereafter. The prepared basecoat compositions are improvable with respect to their yellowing behavior (i.e. coatings like multicoat paint systems comprising coating layers based on the aqueous basecoat compositions tend to successive yellowing, ultimately leading to a decreased optical quality level).

Besides batch-wise production of respective polymers and dispersions, continuous production is in focus of polymer manufactures. Quite obviously, such continuous production depicts inherent advantages compared to batch production procedures, in particular in the context of industrial scale production.

For example, DE 10 2004 017 436 A1 discloses a complex method of continuous production of an aqueous polyurethane dispersion by production of an aqueous pre-emulsion by mixing a polyurethane prepolymer with water in a mixing nozzle and homogenization of the so produced pre-emulsion in a multi-step homogenizing nozzle.

EP2157111 B1 discloses a process for production of an aqueous polyurethan urea resin by mixing a polyurethane prepolymer solution with a low amount of organic solvent (ketones) with water, whereby the prepolymer is prepared by use of an amine-neutralized polyhydroxycarboxylic acid, meaning that the prepolymer is already neutralized before being mixed with water. This feature is made responsible for enabling a dispersing process of the prepolymer with a very low amount of organic solvent, meaning that the resulting dispersion contains likewise a low content of such solvent without the need of distilling off such solvent. While the document, in general form, describes that the process of dispersing may be conducted both batch-wise and in a continuous approach via a rotor/stator unit, the working examples solely are batch-wise processes.

The advantages of continuous production of aqueous resin dispersions, in particular on industrial scale, are self-explanatory. One major challenge regarding continuous dispersion processes, however, must be seen in high differences of the viscosity of the aqueous phase (essentially water) on the one hand side and the polyurethane prepolymer solution (organic-based phase) on the other hand side. Even if fed separately (i.e. in form of separate substance flows) into the dispersing unit, the significantly higher viscosity of the organic phase compared to the aqueous phase remains a problem. While versatile known measures of decreasing the viscosity of the organic phase exist, these measures are accompanied with certain drawbacks. For example, raising the temperature of the polymer means high energy consumption and, even more importantly, may lead to side reactions of the isocyanate groups (the latter being particularly prominent when generally applicable neutralizing agents (tertiary amines) are already present at this stage). Increasing the amounts of organic solvents in the organic phase, quite obviously, results in likewise higher amounts of organic solvent in the resulting aqueous dispersion (and the need of finally distilling off these organic solvents, if a dispersion with low organic volatile content is desired).

### Objective and Technical Solution

From the above, it is apparent that there is a need for aqueous polyurea-polyurethane dispersions and aqueous basecoat compositions containing such dispersions showing improved yellowing behavior. Also, it is desirable to provide a process of continuous production of the prementioned aqueous polyurethane-polyurea dispersions which provides for an optimal and stable dispersive character of the dispersion by concurrently making it possible to produce the dispersion with a very low content of organic solvent. More particularly, these dispersions should be producible with such low content of organic solvent, even if a final respective distillation step of organic solvents is omitted.

It was found that the above objectives are solved by a novel aqueous polyurethane-polyurea dispersion and a process for continuous production of an aqueous polyurethane-polyurea dispersion.

More particularly, the novel aqueous polyurethane-polyurea dispersion comprises polyurethane-polyurea particles having a volume-based mean diameter of 50 to 500 nm, wherein the dispersion is further characterized by an MEQ base of 0.125 to 0.625 meq/g (based on solids content), whereby production of the dispersion involves a neutralization step with at least one alkali metal hydroxide as neutralization agent.

Also found was a novel process for continuous production of an aqueous polyurethane-polyurea dispersion comprising polyurethane-polyurea particles having a volume-based mean diameter of 50 to 500 nm, wherein the dispersion is further characterized by an MEQ base of 0.125 to 0.625 meq/g (based on solids content), which comprises the following steps:
(1) provision of an organic-based phase (I) comprising
(a) at least one acid-functional polyurethane prepolymer containing isocyanate groups, and
(b) from 0 to 20% by weight, based on the total weight of the organic-based phase (I), of at least one organic solvent,
(2) provision of an aqueous phase (II)
(3) continuously feeding both the organic-based phase (I) and the aqueous phase (II) into a high shear dispersion device comprising a rotor/stator unit,
(3.1) wherein the organic-based phase (I) and the aqueous phase (II) are brought into contact within and not before reaching the rotor/stator unit, and
(3.2) wherein the organic phase (I) is fed in form of multiple sub feed streams via multiple inlets into the rotor/stator unit,
(4) continuously dispersing the organic-based phase (I) and aqueous phase (II) in the rotor-stator unit, thereby producing an aqueous polyurethane-based dispersion,
(5) continuously discharging the aqueous polyurethane-based dispersion from the high shear dispersion device, thereby creating a volume flow of the dispersion, and
(6) feeding at least one chain extension agent to the aqueous polyurethane-based dispersion, thereby producing the aqueous polyurethane-polyurea dispersion,
wherein a neutralization step with at least one alkali metal hydroxide as neutralization agent is conducted during the dispersing process according to steps (3) and (4) above.

### BRIEF DESCRIPTION OF FIGURES

FIG. 1 shows a stator (10) having three stator sets of teeth (11) having teeth (12). The first set of teeth (11) having the smallest diameter consist of in total 24 teeth having a distance from each other of, for example, 2.0 mm. The second set of teeth (11) consist of 34 teeth (1.2 mm distance), while the set (11) with the biggest diameter consists of 160 teeth (0.3 mm). Also shown are the first inlet (13) and second inlets (14) arranged in form of a circle and having uniform distances to each other. The figure shows one half of the stator in detail (i.e. with individual teeth (12) and also showing the individual second inlets (14)), while the second half is a schematic figure (set of teeth as circles, individual second inlets not shown).

FIG. 2 shows a rotor (20) having four rotor sets of teeth (21) having teeth (22). The first set of teeth (21) having the smallest diameter consist of 12 teeth in total having a distance from each other of, for example, 3.0 mm. The second set of teeth (20) consist of 28 teeth (1.6 mm distance), while the third set (20) consists of 70 teeth (0.6 mm). The fourth set of teeth (20) having the biggest diameter consists of 160 teeth (0.3 mm). Again, one half is a detailed figure, while the other half is of schematic character.

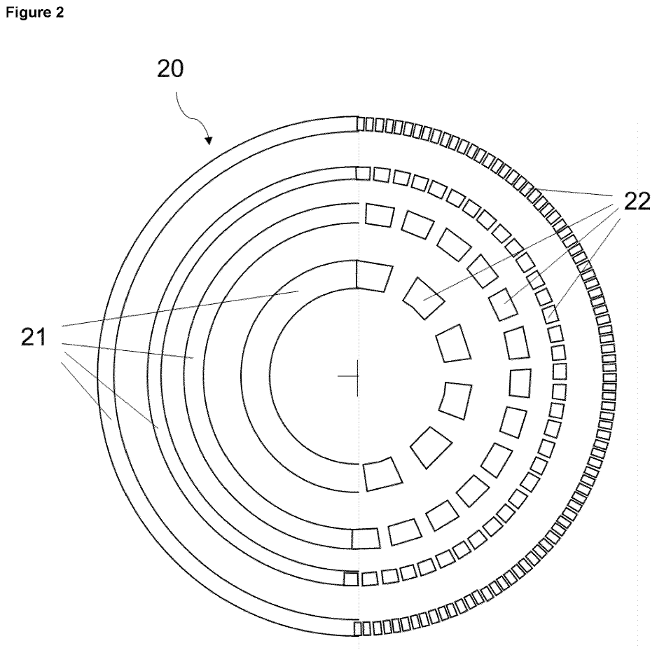

FIG. 3 shows rotor/stator unit as overlap of FIGS. 1 and 2, thereby explicitly referring to the first inlet (13), two second inlets (14), the three stator sets of teeth (11) and the four rotor sets of teeth (21). Furthermore, the stator sets of teeth and three rotor sets of teeth are specified according to their position relative to the set of second inlets. Therefore, sets of rotor teeth to which the second inlets are positioned radially outside are named rotor sets of teeth (21a), while respective stator sets of teeth are named stator set of teeth (11a). Also, sets of rotor teeth to which the second inlets are positioned radially inside are named rotor sets of teeth (21b), while respective stator sets of teeth are named stator set of teeth (11b).

### DETAILED DESCRIPTION

At first, the novel process is described.

In the first step (1) of the process of the invention an organic-based phase (I) is provided.

The organic-based phase (I) comprises at least one acid-functional polyurethane prepolymer (a) containing isocyanate groups.

Polyurethane polymers containing isocyanate groups and being acid-functional are known in principle. For the purposes of the present invention, the respective component (a) is referred to as prepolymer, for greater ease of comprehension. This component is in fact a polymer (or oligomer) which can be referred to as a precursor, since it is used as a starting component for preparing another component, specifically the polyurethane-polyurea polymer within the aqueous dispersion.

For preparing the polyurethane prepolymers which contain isocyanate groups and comprise anionic groups and/or groups which can be converted into anionic groups, it is possible to employ the aliphatic, cycloaliphatic, aliphatic-cycloaliphatic, aromatic, aliphatic-aromatic and/or cycloaliphatic-aromatic polyisocyanates that are known to the skilled person. Diisocyanates are used with preference. Mention may be made, by way of example, of the following diisocyanates: 1,3- or 1,4-phenylene diisocyanate, 2,4- or 2,6-tolylene diisocyanate, 4,4′- or 2,4′-diphenylmethane diisocyanate, 1,4- or 1,5-naphthylene diisocyanate, diisocyanatodiphenyl ether, trimethylene diisocyanate, tetramethylene diisocyanate, ethylethylene diisocyanate, 2,3-dimethylethylene diisocyanate, 1-methyltrimethylene diisocyanate, pentamethylene diisocyanate, 1,3-cyclopentylene diisocyanate, hexamethylene diisocyanate, cyclohexylene diisocyanate, 1,2-cyclohexylene diisocyanate, octamethylene diisocyanate, trimethylhexane diisocyanate, tetramethylhexane diisocyanate, decamethylene diisocyanate, dodecamethylene diisocyanate, tetradecamethylene diisocyanate, isophorone diisocyanate (IPDI), 2-isocyanatopropylcyclohexyl isocyanate, dicyclohexylmethane 2,4′-diisocyanate, dicyclohexylmethane 4,4′-diisocyanate, 1,4- or 1,3-bis(isocyanatomethyl)cyclohexane, 1,4- or 1,3- or 1,2-diisocyanatocyclohexane, 2,4- or 2,6-diisocyanato-1-methylcyclohexane, 1-isocyanatomethyl-5-isocyanato-1,3,3-trimethylcyclohexane, 2,3-bis(8-isocyanatooctyl)-4-octyl-5-hexylcyclohexene, tetramethylxylylene diisocyanates (TMXDI) as m-tetramethylxylylene diisocyanate, or mixtures of these polyisocyanates. Also possible, of course, is the use of different dimers and trimers of the stated diisocyanates, such as uretdiones and isocyanurates. Polyisocyanates of higher isocyanate functionality may also be used. Examples thereof are tris(4-isocyanatophenyl)methane, 1,3,4-triisocyanatobenzene, 2,4,6-triisocyanatotoluene, 1,3,5-tris(6-isocyanatohexylbiuret), bis(2,5-diisocyanato-4-methylphenyl)methane. The functionality may optionally be lowered by reaction with monoalcohols and/or secondary amines. Preference, however, is given to using diisocyanates, more particularly to using aliphatic diisocyanates, such as hexamethylene diisocyanate, isophorone diisocyanate (IPDI), dicyclohexylmethane 4,4′-diisocyanate, 2,4- or 2,6-diisocyanato-1-methylcyclohexane, and m-tetramethylxylylene diisocyanate (m-TMXDI). An isocyanate is termed aliphatic when the isocyanate groups are attached to aliphatic groups; in other words, when there is no aromatic carbon present in alpha position to an isocyanate group.

The prepolymers (a) are prepared by reacting the stated polyisocyanates with polyols, more particularly diols, generally with formation of urethanes.

Examples of polyols are the generally known polyester, polycarbonates, polyether, polydiene, polyene, poly(meth)acrylate and/or polysiloxane polyols, more particularly diols. Mixtures of polyols are likewise possible.

Preferred examples of suitable polyols are saturated or olefinically unsaturated polyester polyols and/or polyether polyols. Polyols used more particularly are polyester polyols, especially those having a number-average molecular weight of 400 to 5000 g/mol (for measurement method, see Example section). Such polyester polyols, preferably polyester diols, may be prepared in a known way by reaction of corresponding polycarboxylic acids, preferably dicarboxylic acids, and/or their anhydrides with corresponding polyols, preferably diols, by esterification. It is of course optionally possible in addition, even proportionally, to use monocarboxylic acids and/or monoalcohols for the preparation. The polyester diols are preferably saturated, more particularly saturated and linear.

Examples of suitable aromatic polycarboxylic acids for preparing such polyester polyols, preferably polyester diols, are phthalic acid, isophthalic acid, and terephthalic acid, of which isophthalic acid is advantageous and is therefore used with preference. Examples of suitable aliphatic polycarboxylic acids are oxalic acid, malonic acid, succinic acid, glutaric acid, adipic acid, pimelic acid, suberic acid, azelaic acid, sebacic acid, undecanedicarboxylic acid, and dodecanedicarboxylic acid, or else hexahydrophthalic acid, 1,3-cyclohexanedicarboxylic acid, 1,4-cyclohexanedicarboxylic acid, 4-methylhexahydrophthalic acid, tricyclodecanedicarboxylic acid, and tetrahydrophthalic acid. As dicarboxylic acids it is likewise possible to use dimer fatty acids or dimerized fatty acids, which, as is known, are mixtures prepared by dimerizing unsaturated fatty acids and are available, for example, under the commercial names Radiacid (from Oleon) or Pripol (from Croda). In the present context, the use of such dimer fatty acids for preparing polyester diols is preferred. Polyols used with preference for preparing the prepolymers (a) are therefore polyester diols which have been prepared using dimer fatty acids. Especially preferred are polyester diols in whose preparation at least 50 wt %, preferably 55 to 75 wt %, of the dicarboxylic acids employed are dimer fatty acids.

Examples of corresponding polyols for preparing polyester polyols, preferably polyester diols, are ethylene glycol, 1,2- or 1,3-propanediol, 1,2-, 1,3-, or 1,4-butanediol, 1,2-, 1,3-, 1,4-, or 1,5-pentanediol, 2,2-dimethyl-1,3-propanediol (neopentylglycol), 2-methyl-2,4-pentanediol, 1,2-, 1,3-, 1,4-, 1,5-, or 1,6-hexanediol, trimethylpentanediol, 1,2-, 1,3-, or 1,4-cyclohexanediol, 1,2-, 1,3-, or 1,4-cyclohexanedimethanol, bifunctional alcohols which are alpha-, omega- or alpha-, beta-dihydroxyalkanes from eight to twenty-five carbon atoms, particularly 1,2-octanediol, 1,8-octanediol, 1,2-decanediol, 1,10-decanediol, 1,2-dodecanediol, 1,12-dodecanediol, 1,13-tridecanediol, 1,2-octadecanediol, 1,18-octadecanediol, 1,2-heneicosanediol, 1,21-heneicosanediol and 1,25-pentacosanediol. Furthermore examples of corresponding polyols for preparing polyester polyols, preferably polyester diols, are polyols based on the hydrogenation products of methylesters of polycarboxylic acids which are derived from dimeric and trimeric fatty acids, for example, the dimer fatty C36 diol after hydrogenation of the methylester of saturated dimeric C36 fatty acid (Pripol® 2033; from Croda) More examples of corresponding polyols for preparing polyester polyols, preferably polyester diols, are ether oder cyclic ether alcohols like, diethylene glycol, triethylene glycol, tetraethylene glycol, 2,5-bis(hydroxymethyl)furane, 2,5-bis(hydroxymethyl)terahydrofurane, as well as carbohydate-based cyclic etheralcohols such as isosorbide, isomannide, and isoidide, and ester alcohols like 3-hydroxy-2,2-dimethylpropyl-3-hydroxy-2,2-dimethylpropionate (neopentyl glycol mono(hydroxypivalate)).

Polyhydroxy-polyesters which are derived from polyhydroxyalkyl acids, like poly 2-hydroxyethanoic acid (polyglycolic acid) or polyhydoxypropionic acid, its other name is poly(lactic acid) (polylactides), and polyhydroxyalkyl acids with higher number of carbon atoms can also be used. The direct method is based on the direct polycondensation of hydroxycarboxylic acids as alpha, beta, gamma or omega-hydroxylic acids. Due to the presence of a hydroxyl group and carbonyl group, examples of corresponding hydroxycarboxylic acids are 2-hydroxyethanoic acid (glycolic acid), 2-hydroxypropionic acid, 3-hydroxypropionic acid (lactic acid), 3-hydroxy-2-methylpropanoic acid, 3-hydroxybutanoic acid, 4-hydroxybutanoic acid, 3-hydroxypentanoic acid, 5-hydroxypentanoic acid up to 12-hydroxydodecanoic acid (sabinic acid) or 13-hydroxytridecanoic acid. It is also possible and preferred to form polyester diols based on polyhydroxyalkyl acids by ring-opening polymerization of cyclic oligomers, preferred dimers, of the corresponding hydroxycarboxylic acids, for example dilactides from corresponding lactic acid to form the best-known biode-gradable polymer poly(lactic acid)

The term polyester diol is also to be understood as meaning polylactone diols, obtained by reaction of a lactone with polyol as an initiator that has active hydrogen-containing groups; illustrative of which is ethylene glycol, diethylene glycol, propanediols, 1,4-butanediol, 1,5-pentandiol or 1,6-hexanediol, and generated by ring opening polymerization. Lactones which can be used for the synthesis of the polyester polyols are butyrolactone, valerolactone, methylvalerolactone, caprolactone, methylcaprolactone, and 2-oxocanone (enantholactone). The preferred lactone polyols are known as polycaprolactone polyols.

Further examples of suitable polyols are polycarbonate polyols, more particularly polycarbonate diols. These polycarbonate polyols can be prepared by reaction of polyols, such as 1,3-propanediol, 1,4-butanediol, 1,5-pentanediol, 2-methylpentane-1,3-diol, neopentylglycol, 1,6-hexanediol, 2,2,4-trimethylpentane-1,3-diol, 2-butyl-3-ethylpropan-1,3-diol, trimethylolpropane or pentaerythritol, 1,4-bishydroxymethylcyclohexane, 2,2-bis(4-hydroxycyclohexyl)propane, diethylene glycol, triethylene glycol or tetraethylene glycol, with di-carbonates, such as dimethyl, diethyl or diphenyl carbonate, or phosgene.

Further oligomeric or polymeric hydroxy-functional compounds are polydiene or polyene, and there are at least two, preferably terminal, hydroxyl groups per molecule. Particularly preferredare dihydroxy compounds based on polybutadiene, polyisoprene or polyolefin, like polyethylene (hydrogenated polybutadiene) and polybutadiene, polyisoprene or polyolefin block copolymers with polystyrene.

Examples of polyether polyols here include polyols of polyoxyethylene, polyoxypropylene polyoxybutylene, mixed and block copolymers of these, in blocks or randomly distributed along the polymer chain, and, polyoxytetramethylene (polytetrahydrofurane, for example PolyTHF 2000 from BASF SE) containing terminal OH groups, also simply known as glycols. Again, diols are preferred.

These polyols are conventional materials and commercially available.

Eligible polyols are further exemplified by alpha, omega-dihydroxy poly(meth)acrylates (for example TEGO® Diol MD 1000 of Evonik Tego Chemie GmbH) and alpha, omega—polydialkylsiloxane diols, like polydimethylsiloxane diols.

Diols are used with preference. The prementioned polyols and/or diols may of course also be used directly for preparing the prepolymer (a), in other words reacted directly with polyisocyanates.

Further possibilities for use in preparing the prepolymers (a) are polyamines such as diamines and/or amino alcohols. Examples of diamines include hydrazine, alkyl- or cycloalkyldiamines such as propylene diamine and 1-amino-3-aminomethyl-3,5,5-trimethylcyclohexane, and examples of amino alcohols include ethanolamine or diethanolamine.

The prepolymers (a) are acid-functional (i.e. contain groups which can be converted into anionic groups by the use of known neutralizing agents)). As the skilled person is aware, these groups are, for example, carboxylic, sulfonic and/or phosphonic acid groups, especially preferably carboxylic acid groups. The introduction of such groups is known to increase the dispersibility in water. Depending on the conditions selected, the stated groups may be present proportionally or almost completely in the one form (carboxylic acid, for example) or the other form (carboxylate). The particular influencing factor residesin the use of neutralizing agents which are described in more detail later on below. If a prepolymer (a) is mixed with such neutralizing agents, then an amount of acid groups is converted into the corresponding base groups, whereby this amount corresponds with the amount of the neutralizing agent. Where, for example, a polymer has a particular amount of carboxylic acid groups, a part or all of these may be converted into carboxylate groups (the corresponding base) by such neutralizing agents. The amount of carboxylic acid groups may be described by the acid number (determined as described in the examples) or MEQ acid (which is the molar amount of acid groups [mmol] per mass of polymer [g]). The amount of (corresponding) base groups, for example carboxylate groups, may be described as MEQ base (i.e. the molar amount of basic groups [mmol] per mass of polymer [g]). It can be either determined experimentally via titration (DIN EN ISO 15880, cf. also examples) or calculated from the acid number of a non-neutralized polymer and the amount of neutralizing agent applied for neutralization.

The above describes, by means of example in the context of the prepolymer (a), the general principles and conditions of neutralization and conversion of acid groups into the corresponding base groups. Preferably, however, the prepolymer (a) as such is not neutralized in the context of the present invention. Rather, in the context of the inventive process, it is essential that a step of neutralization is conducted at a later stage in the process, i.e. during the below described dispersing process (i.e. at a stage where the prepolymer is dispersed with an aqueous phase, meaning that at this stage the prepolymer starts to convert and a polyurethane-based dispersion eventually results). Finally, however, the respective acid groups of the prepolymer are of course also part of the polymer species comprised in the polyurethane-based dispersion or in the finally produced polyurethane-polyurea dispersion. Therefore, the principles of neutralization, quite obviously, are generally valid.

In order to introduce the stated acid groups, it is possible, during the preparation of the prepolymers (a), to use starting compounds which as well as groups for reaction in the preparation of urethane bonds, preferably hydroxyl groups, further comprise the abovementioned groups, carboxylic acid groups for example. In this way the groups in question are introduced into the prepolymer.

Corresponding compounds contemplated for introducing the preferred carboxylic acid groups are polyether polyols and/or polyester polyols, provided they contain carboxyl groups. However, compounds used with preference are at any rate low molecular weight compounds which have at least one carboxylic acid group and at least one functional group reactive toward isocyanate groups, preferably hydroxyl groups. In the context of the present invention, the expression “low molecular weight compound”, as opposed to higher molecular weight compounds, especially polymers, should be understood to mean those to which a discrete molecular weight can be assigned, as preferably monomeric compounds. A low molecular weight compound is thus, more particularly, not a polymer, since the latter are always a mixture of molecules and have to be described using mean molecular weights. Preferably, the term “low molecular weight compound” is understood to mean that the corresponding compounds have a molecular weight of less than 300 g/mol. Preference is given to the range from 100 to 200 g/mol.

Compounds preferred in this context are, for example, monocarboxylic acids containing two hydroxyl groups, as for example dihydroxypropionic acid, dihydroxysuccinic acid, and dihydroxybenzoic acid. Very particular compounds are alpha, alpha-dimethylolalkanoic acids such as 2,2-dimethylolacetic acid, 2,2-dimethylolpropionic acid, 2,2-dimethylolbutyric acid and 2,2-dimethylolpentanoic acid, especially 2,2-dimethylolpropionic acid.

Preferably, therefore, the prepolymers (a) applied in the process are carboxy-functional. They preferably possess an acid number of 10 to 35 mg KOH/g, more particularly 15 to 23 mg KOH/g (based on solids content). As already described above, the prepolymers (a) applied in the process are preferably not neutralized, meaning that the MEQ base of the prepolymer (a) is 0 mmol/g or at least substantially 0 mmol/g.

As mentioned above, the prepolymer (a) preferably is build-up from difunctional compounds like, in particular, diisocyanate and diols. Therefore, it is evident that the prepolymer preferably is of linear character.

As outlined above, the prepolymer (a) contains isocyanate groups. The polyurethane prepolymer preferably has an isocyanate equivalent weight of below 3000 g/mol. More preferably, the isocyanate equivalent weight is below 2500 g/mol. Preferred ranges are from 500 to 3000 g/mol, even more preferably from 1000 to 2500 g/mol (determined via NCO content of the prepolymer (solids content)).

It is preferred that the prepolymer (a) has a number-average molecular weight of at most 6000 g/mol, for example in the range from 1000 to 6000 g/mol, more preferably from 2000 to 5000 g/mol. The comparably low molecular weight contributes to a likewise low viscosity of the prepolymer, meaning that a more aligned viscosity with the below-described aqueous phase (II) and, therefore, an enhanced dispersibility is reached.

The prepolymers (a) may be prepared by known and established methods in bulk or solution, especially preferably by reaction of the starting compounds in organic solvents, such as preferably methyl ethyl ketone, at temperatures of, for example, 60 to 120 °C, and optionally with use of catalysts typical for polyurethane preparation. Such catalysts are known to those skilled in the art, one example being dibutyltin laurate. The procedure here is of course to select the proportion of the starting components such that the product, in other words the prepolymer (a), contains isocyanate groups. It is likewise directly apparent that the solvents ought to be selected in such a way that they do not enter into any unwanted reactions with the functional groups of the starting compounds, in other words being inert toward these groups to the effect that they do not hinder the reaction of these functional groups. The preparation is preferably actually carried out in an organic solvent (b) as described below. Also, the fraction of organic solvent for preparing the prepolymer (a), based on synthesis mixture (i.e. mixture containing starting compounds and organic solvents), preferably does not exceed the fraction of organic solvents (b) in the organic-based phase as defined below.

The organic-based phase (I) may also comprises at least one organic solvent (b). Quite obviously, this organic solvent may be the one or those applied within the manufacturing process of the prepolymer (a).

Regarding the organic solvents (b), those being known to the person skilled in the art may be applied and no particular restrictions apply. For example, as solvents (b) ketones, ether, ester, pyrrolidones, amides, morpholines, lactones, acetates or sulfoxides may be applied. Explicit examples of solvents (b) are methyl ethyl ketone, methyl isobutyl ketone, diisobutyl ketone, diethyl ether, dibutyl ether, dipropylene glycol dimethyl ether, ethylene glycol diethyl ether, diethylene glycol dibutyl ether, diglycol acetate, toluene, methyl acetate, ethyl acetate, butyl acetate, propylene carbonate, cyclohexanone, acetone, N-methyl-2-pyrrolidone, N-ethyl-2-pyrrolidone, tetrahydrofuran, dioxane, N-formylmorpholine, dimethylformamide, or dimethyl sulfoxide, 3-methoxy-N,N-dimethyl propione amide, 3-butoxy-N,N-dimethyl propione amide, N-formyl morpholine, gamma-butyro lactone, bis(2-(2-butoxy ethoxy)ethoxy) methane.

The fraction of the at least one organic solvent (b) is not more than 20% by weight (20 wt.-%), based on the total weight of the organic-based phase (I). Therefore, the organic-based phase (I) may even be entirely free of such organic-solvent (meaning that in such a case the organic-based phase may consist of the prepolymer (a)). However, for the reason of appropriately low viscosity, the fraction of the at least one organic solvent (b) preferably is not less than 5% by weight. Preferably, the fraction is from 5 to 20% by weight, more preferably from 10 to 15% by weight, in each case based in the total weight of the organic-based phase. The comparably low fraction of organic solvents, together with further features and technical characteristics of the process of the invention as described below, ensure that the finally resulting aqueous polyurethane-polyurea dispersion is preparable with a very low content of organic solvents without the need of a respective distillation process of such solvents.

The solids content of the organic-based phase (I) preferably is at least 80% by weight, more preferably at least 85% by weight, but preferably below 90% by weight. Preferred ranges are from 80 to 95% by weight like, for example, 85 to 90% by weight.

In the second step (2) of the process of the invention an aqueous phase (II) is provided. Quite obviously, the second step may take place before or after or in parallel to the first step (1).

The aqueous phase (II), apparently, comprises water. Besides water, of course, the aqueous phase may also include, proportionally, typical auxiliaries such as typical emulsifiers and protective colloids. A compilation of suitable emulsifiers and protective colloids is found in, for example, Houben Weyl, Methoden der organischen Chemie [Methods of Organic Chemistry], volume XIV/1 Makromolekulare Stoffe [Macromolecular compounds], Georg Thieme Verlag, Stuttgart 1961, p. 411 ff. Also, the aqueous phase may include hydroxides of alkali metals as neutralizing agents, meaning that this contributes to or fully covers the essential step of neutralization during the dispersing procedure. However, water of course makes up the majority of the aqueous phase (II) like, for example, at least 90% by weight or even at least 95% by weight.

In step (3) of the process of the invention the organic-based phase (I) and aqueous-based phase (II) are continuously fed into a high shear dispersion device comprising a rotor/stator unit. It is essential that the two phases are brought into contact within the rotor/stator unit and thus not before reaching this rotor/stator unit. As a standard, a high shear dispersion device comprises one rotor/stator unit. In the unlikely case that more than one such unit is present in the device, the above-mentioned rotor/stator unit of course is the first unit into which both the organic-based phase (I) and aqueous-based phase (II) are fed.

High shear dispersion devices comprising rotor/stator units as well as their application for continuous dispersing processes are well known in the art. For example, EP 1 489 130 B1 or U.S. Pat. No. 8,669,401 B2 describe details on such units in the context of continuous production of polyurethane emulsions or wax dispersions.

Therefore, such rotor/stator units comprise a rotor subunit and a stator subunit. Both the rotor and stator subunit comprise at least one set of teeth, whereby the teeth of each set are assembled circumferentially on a circle with a certain circumference and diameter, respectively. The at least one set of the rotor and the at least one set of the stator are aligned to each other in a way that the respective teeth of rotor and stator (each describing a circle) are oriented concentrically to each other. In case of more than one set of teeth of rotor and/or stator (which is preferred in the context of the present invention), the sets of teeth of rotor and stator are arranged alternatingly. Within known rotor/stator units, the to be dispersed liquid components are centrically introduced into the device and respective rotation of the rotor results in exposing the liquids to a centrifugal force, ultimately pushing the medium outwards. The rotor movement also leads to rotation of the rotor teeth against the fixed teeth of the stator and thus exposing shear to the liquids when flowing outwards through the respectively dynamically changing cavities/cavity sizes of the unit. More specifically, the dynamic changing of the cavities/the size of cavities is based on the mentioned rotation of the rotor teeth against the stationary stator teeth. Quite obviously, versatile parameters and adjustments are possible, like for example the number and size of teeth, diameter of the set of teeth (that is the circle on which the teeth are positioned), the width of gaps/distances between the teeth of one set and/or the distance of rotor and stator set(s) of teeth (that is the concentrical distance between the teeth of a rotor set of teeth and the teeth of an adjacent stator set of teeth) or the number of sets of teeth of the rotor and stator. These parameters, generally, are adjustable based on individual needs and based on the general knowledge of the person skilled in the art. As a general rule, with increasing diameter of a set of teeth, often the number of teeth is increasing, while the size of the teeth and the withs of gaps is decreasing (meaning that an increasing number of break up walls and thus shear stress (at a given rotor velocity) is present).

Preferably, the rotor/stator unit comprises at least two sets of teeth of a rotor (21) and at least two sets of teeth of a stator (11). Even more preferably, at least three sets of teeth of a rotor (21) and at least three sets of teeth of a stator (11). Even more preferably, four sets of teeth of a rotor (21) and three set of teeth of a stator (11) are comprised. As mentioned above, the set of teeth of rotor (21) and set of teeth of stator (11) are of course arranged alternatingly. Therefore, in the above-described scenario where four sets of teeth of a rotor (21) and three set of teeth of a stator (11) are comprised, the first set of teeth of the rotor (21) has the overall smallest diameter (thus lying most centrically) and the fourth set of teeth (21) has the overall biggest diameter (thus lying mots outwards).

(3.1) As outlined above, the two phases, namely the organic-based phase (I) and the aqueous phase (II), are brought into contact within the rotor/stator unit and thus not before reaching this rotor/stator unit. Accordingly, quite obviously, a first requirement is that the two phases are separately supplied as two separate feed streams via two separate inlets into the high shear dispersion device and thus into the rotor/stator unit.

(3.2) Also, it is crucial that the organic phase (I) is fed in form of multiple sub feed streams via multiple inlets into the rotor/stator unit. Therefore, the organic phase (I), for example initially provided as one (main) feed stream, is split into multiple sub feed streams before reaching the rotor/stator unit and thus is supplied as such multiple sub feed streams into the unit.

It has been emerged that the above features (3.1) and (3.2) are crucial for reaching the objectives of the present applications, i.e. to provide for an aqueous polyurethane-polyurea dispersion which provides for an optimal and stable dispersive character of the dispersion by concurrently making it possible to produce the dispersion with a very low content of organic solvent. More particularly, the two separate feed streams (3.1) ensure a continuous, constant and controllable feeding of both phases into the unit (contrary to a single feed stream comprising both phases, as in this scenario the viscosity difference of the two phases impedes such continuous, constant and controllable feeding), while the feeding of the organic phase in form of multiple sub feed streams (3.2) serves for enhanced dispersing effectiveness.

Preferably, in a first aspect, the above principle involves one first inlet into the rotor/stator unit being located centrically within unit, i.e. inside the circle described by the smallest und thus most inside set of teeth (which is either a set of teeth of the rotor or of the stator). The inlet, of course, is part of the stator. Accordingly, this first aspect is equal to the inlet of a standard rotor/stator unit. This first inlet is provided for the aqueous phase (II) and the feed stream of the aqueous phase (II), respectively.

As mentioned above, the novel process involves feeding the organic phase (I) via multiple inlets. These inlets, for distinction from the first inlet for the organic phase (I) described above, may also be named second inlets. These multiple inlets (i.e. multiple second inlets or set of second inlets) is provided for the organic phase (I) and the multiple sub feed streams of the organic phase (I), respectively. The inlets, of course, are part of the stator. The set of second inlets result from a partition of one main inlet pipe into the rotor/stator unit. In other words, one main feed line is split into a respective number of supply inlets.

The number of second inlets making up the set of second inlets preferably is at least 5, more preferably at least 10 or even at least 20. Of course, the exact number of second inlets depends on further factors like overall size of the respective rotor/stator unit or size (i.e. inner diameter) of the inlets. The inner diameter of the second inlets also may vary and be selected according to individual needs. For example, an appropriate size of second inlets may be influenced by the viscosity of the organic phase (I) or its mass flow. Exemplary size ranges (without implying any limitation, but only a preference) may be from 1.5 to 10 mm like for example 1.8 to 7.5 mm or 1.8 to 5 mm (inner diameter).

One decisive advantage of this setup is that the organic phase (I) already is exposed to a certain level of shear before even reaching the rotor/stator unit (due to the geometry of the multiple inlets, i.e. a comparably high number of wall surfaces and thus pronounced turbulence). Also, it means that the organic phase (I) reaches the rotor/stator unit initially well distributed as being fed not via one single main feed stream but split into multiple sub feed streams.

The set of second inlets may be arranged in different types and manner. The second inlets as part of the stator may be located, for example, between the central first inlet and the first set of teeth of the stator (i.e. the set of teeth of the stator with the smallest diameter). Also, the second inlets may be located between two sets of teeth of the stator. Obviously, also a first portion of the second inlets may be located between the central first inlet and the first set of teeth of the stator, while a second portion is located between two sets of teeth of the stator (or the second portion may even be divided into groups of inlets located between different pairs of set of teeth of the stator). It is preferred that at least a portion of the second inlets, more preferably all of the second inlets, are positioned between two sets of teeth of the stator.

It is preferred that the second inlets, as part of the stator, are located circumferentially on a circle with a certain circumference and diameter. The second inlets preferably are uniformly distributed over the above-named circle, i.e., are positioned on such a circle in uniform distance to each other. From the above follows that it is preferred that this circle has a circumference and thus diameter lying between the circumference and thus diameter of one first set of teeth of the stator and the circumference and thus diameter of one second set of teeth of the stator, meaning that the second inlets are positioned between two sets of teeth of the stator.

Preferably, the set of second inlets is a set of inlets (i.e. holes) located circumferentially on a circle having a circumference and diameter being greater than the circumference and diameter of at least one set of stator teeth and at least one set of rotor teeth.

Preferably, a portion of second inlets (preferably all second inlets) are positioned radially outside of at least one set of rotor teeth and at least one set of stator teeth like, for example, radially outside of two sets of rotor teeth and one set of stator teeth (lying between the two sets of rotor teeth). For greater clarity, sets of rotor teeth to which the second inlets are positioned radially outside may be named rotor sets of teeth (21a), while respective stator sets of teeth may be named stator set of teeth (11a).

Thus, in preferred embodiments the second inlets are located at positions where a fluid entering the unit via the first inlet (i.e. the aqueous phase (II)) is passing by in form of already having been exposed to shear via the unit.

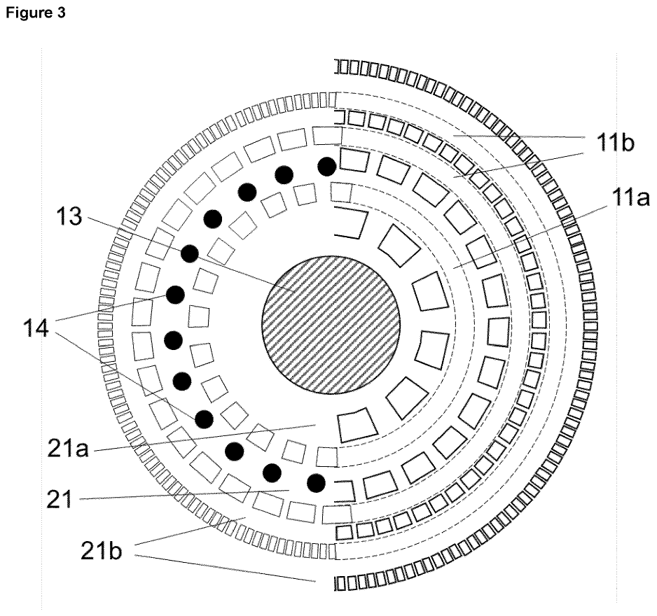

As the sets of rotor and stator teeth in a rotor/stator device are located concentrically to each other and, in case of more than one set of teeth of rotor and/or stator, the sets of teeth of rotor and stator are arranged alternatingly, the set of second inlets as part of the stator preferably are located on a circle also at least substantially describing a circle of a set of rotor teeth (cf. FIG. 3). Therefore, the set of second inlets (being holes in the stator) lie directly or approximately (i.e. slightly staggered) beneath the teeth of the respective rotor set of teeth. The respective spaces defined by these conditions then are the areas where a first fluid entering the unit via the first inlet is brought into contact with a second fluid entering the unit via the set of second inlets.

Obviously, the organic phase (I) entering the unit via the set of second inlets needs to be effectively dispersed with the aqueous phase (II) and thus needs to be effectively exposed to shear to effect appropriate dispersibility character. Therefore, preferably the rotor/stator unit comprises at least one combination of a set of rotor teeth and a set of stator teeth radially outside of the positions of the second inlets. Therefore, in the case where the set of second inlets is arranged as a circle, the circumference and diameter of this circle is smaller than the circumference and diameter of at least one set of stator teeth and at least one set of rotor teeth.

Therefore, preferably, a portion of the second inlets (preferably all second inlets) are positioned radially inside of at least one set of rotor teeth and at least one set of stator teeth like, for example, radially inside of two sets of rotor teeth and two sets of stator teeth (arranged alternatingly). For greater clarity, sets of rotor teeth to which the second inlets are positioned radially inside may be named rotor sets of teeth (21b), while respective stator sets of teeth may be named stator set of teeth (11b).

As the person skilled in the art knows, the viscosity of the organic phase comprising a polyurethane-prepolymer and a comparably low solvent content will be significantly higher than the viscosity of the aqueous phase. Surprisingly, the above setup copes with these hurdles, i.e., guarantees an effective dispersion process despite respective deviations of viscosities of the to be mixed phases.

As mentioned above, the organic phase may be heated before being introduced into the high shear dispersion device and thus rotor/stator unit. This, quite obviously, serves for a decreased viscosity. Preferably, the temperature of the organic phase (I), when being introduced into the rotor/stator unit and when being brought into contact with the aqueous phase (II), is of at least 50 °C, more preferably of at least 65 °C or even at least 75 °C. Preferred ranges are from 50 to 160 °C, more preferably 65 to 140 °C or even 75 to 120 °C.

The organic phase, when being introduced into the rotor/stator unit preferably has a viscosity of below 35 Pas, preferably 15 to 30 Pas (measured via rotational viscosimeter at a shear rate of 10/s). This viscosity may be reached when heating the organic phase to a temperature as mentioned above.

Preferably, the temperature of the aqueous phase (II), when being introduced into the rotor/stator unit and when being brought into contact with the organic phase (I), is of below 25 °C, more preferably of below 15 °C or even of below 10 °C. Preferred ranges are from 1 to 15 °C, more preferably 2 to 10 °C. As generally known, at such temperatures the viscosity of water and thus of an aqueous phase (II) will be significantly lower than the viscosity of the above-mentioned organic phase (I) (for example, below 10 mPa·s at a shear rate of 1000/s).

The preferably low temperature of the aqueous phase, quite obviously, serves for a compensation of the preferably higher temperature of the organic phase, meaning that after bringing the phases into contact and thus starting the continuous dispersion step (4) of the process of the invention, the emerging aqueous polyurethane-based dispersion may have a moderate temperature. In order to intensify this cooling effect, also the rotor/stator unit or parts thereof may be cooled by external measures. The same, in principle, applies for the fluid pipe system in connection with the outlet of the rotor/stator unit. The temperature, of course, also depends on the weight ratio and thus mass flow of the two different phases during production of the aqueous polyurethane-based dispersion, but preferably is between 30 to 80 °C or even 40 to 70 °C when leaving the rotor/stator unit. One reason is that—differently to the prepolymer and organic-based phase (I)—the emerging aqueous dispersion often has a higher viscosity at higher temperatures, meaning that too high temperature may lead to inappropriate flow.

The ratio of the mass flow of the organic phase (I) and the mass flow of the aqueous phase (II), when entering the rotor/stator unit, may be selected according to individual needs like, for example, the desired solids content of the resulting dispersion. The ratio (I):(II) may be, for example, 1:4 to 1.5:1.

As already mentioned above, it is essential that production of the aqueous polyurethane-polyurea dispersion involves a neutralization step with at least one alkali metal hydroxide as neutralization agent conducted during the dispersing process according to steps (3) and (4) above. The “dispersing process” means the step of actual dispersion according to steps (3) and (4) of the process of the invention, i.e. the steps where the two phases are brought into contact and then dispersed within the rotor/stator unit. During this, quite obviously, the acid groups initially present within the prepolymer are at least partly neutralized, i.e. converted into the corresponding base. While, in principle, neutralization may take place not only during the dispersing process, but also before or after this dispersing process, it is preferred that no such neutralization takes place before the dispersing step, e.g. during formation of the prepolymer or directly thereafter. A prominent advantage from this is that potential side reactions between isocyanate groups and neutralizing agents are avoided or at least diminished. The latter is particularly important in cases where the organic-based phase is heated before the dispersing process in order to decrease its viscosity. Details are mentioned below.

As already mentioned above, neutralization during the dispersing process preferably is realized by including alkali metal hydroxides as neutralization agents into the aqueous phase (II).

In cases where a further neutralization step is conducted after the dispersing process, this may be conducted, for example, by simple addition of neutralizing agent (for example in form of an aqueous solution) into a final holding vessel for the to be produced aqueous polyurethane-polyurea dispersion or in form of a continuous feeding via a T joint in the pipe system, for example.

It is preferred that within the process of the invention no organic bases containing nitrogen, such as amines, such as ammonia, trimethylamine, triethylamine, tributylamines, dimethylaniline, triphenylamine, dimethylethanolamine, methyldiethanolamine, or triethanolamine, and also mixtures thereof, are applied as neutralizing agents. Even more preferably, within the process of the invention only alkali metal hydroxides are applied as neutralizing agents.

Once finally produced, the aqueous polyurea-polyurethane dispersion is characterized by an MEQ base of 0.125 to 0.625 mmol/g (based on solids). Accordingly, in case of a comparably high acid number of the applied prepolymer (a) and thus of the finally produced aqueous polyurea-polyurethane dispersion, a high degree of neutralization would lead to a comparably high MEQ base. In case of a comparably low acid number of the applied prepolymer (a) and thus of the finally produced aqueous polyurea-polyurethane dispersion, a low degree of neutralization would lead to a comparably low MEQ base. Preferred ranges of MEQ base are from 0.15 to 0.5 mmol/g or even 0.20 to 0.40 mmol/g.

In a preferred embodiment, the degree of neutralization of the finally produced aqueous polyurethane-polyurea dispersion is greater than 65%, like for example greater than 66% or even greater than 70%. Overall, the degree of neutralization of the finally resulting aqueous polyurethane-polyurea dispersion preferably is from above 70 to 95%.

It is preferred to conduct a two-step neutralization process, i.e. a first neutralization step during the dispersing step as defined above and a second neutralization step after the dispersing step, preferably in form of an addition of an alkali metal hydroxide as neutralization agent to the final collecting vessel. From the above follows that the first neutralization step thus preferably is conducted at a temperature of the to be neutralized mixture of 30 to 80 °C or 40 to 70 °C. The second neutralization step is preferably conducted at a temperature of the to be neutralized mixture of below 35 °C like for example 10 to 30 °C (i.e. room temperature). Thereby, the degree of neutralization realized in the first step is preferably between 50 and 70%, while the degree of neutralization realized in the second step is from above 70 to 95% (as sum of the first and second step) (degree of neutralization in each case calculated as molar ratio of existing potentially anionic groups in the prepolymer and the amount of neutralizing groups in the applied neutralization agent (cf. example section for further details), always considering the respective mass flows of the respective phases in the continuous process).

While neutralization may be relevant for stabilizing the aqueous polyurethane-polyurea dispersion, addition of the neutralization agent at different temperatures and/or conditions/reaction progresses during the inventive process may have influence on viscosity and particle size of the final aqueous polyurethane-polyurea dispersion. The above preferred embodiments take care of optimizing the resulting aqueous polyurethane-polyurea dispersion in view of these influences.

During the continuous dispersion step (4) an aqueous dispersion comprising polyurethane-based species is formed. Obviously, during this process and thereafter an amount of isocyanate groups of the prepolymer will react with water to form primary amino groups. These emerging amino groups, then, will react in turn with remaining isocyanate groups of the prepolymer. These reactions will unavoidably take place as of the moment of bringing the two phases (I) and (II) into contact with each other, i.e. within the rotor/stator unit and also during and after continuously discharging the aqueous polyurethane-based dispersion from the high shear dispersion device within step (5) of the process of the invention.

Still, in step (6) of the process of the invention, at least one chain extension agent is continuously fed to the aqueous polyurethane-based dispersion discharged from the rotor/stator unit, thereby producing the aqueous polyurethane-polyurea dispersion. Accordingly, the chain extension agent reacts with the polyurethane-based species in the polyurethane-based dispersion, more particularly with isocyanate groups of these polyurethane-based species. Therefore, quite obviously, it has to be taken care that an amount of isocyanate groups will remain for reaction with the chain extension agent. As the person skilled in the art knows, the reaction of isocyanate with water (leading to amino groups which then in turn will consume further isocyanate) does not take place on an extremely quick reaction scale, meaning that addition and (comparably fast) reaction with a chain extension agent will be possible. That is, the reactions and conversions referred to above proceed in parallel with one another. Ultimately, as a result of this intermolecular and intramolecular reaction or crosslinking, a dispersion is formed which comprises polyurethane-polyurea particles.

As described above, in step (6) at least one chain extension agent is fed to the aqueous polyurethane-based dispersion discharged from the rotor/stator unit, meaning that a chain extension reaction with isocyanate is conducted.

As chain extension agents, those agents being established and known to the person skilled in the art may be applied. Therefore, the chain extension agents have N—H functionality, e.g. in form of primary or secondary amino groups or a hydrazine moiety.

Therefore, exemplary chain extension agents are aliphatic, aromatic, or araliphatic (mixed aliphatic-aromatic) polyamines like diamines or triamines and also hydrazine or hydrazides.

Explicit examples are ethylene diamine (EDA), diethylene triamine (DETA), 3-(2-aminoethylamino)propylamine (N3-Amine), dipropylene triamine (DPTA), triethylene meta-tetramine (TETA), N,N′-bis-(3-aminopropyl)ethylene diamine (N4-Amine), xylylenediamine (MXDA), N-(2-aminoethyl) ethanolamine (AEEA), N-(2-aminoethyl) propanolamine (AEPA), 2-methyl pentane diamine, and the like, and mixtures thereof. Also suitable for practice in this invention are 1,2-propane diamine, 1,3-propane diamine, 1,3-butane diamine, 1,4-butane diamine, 2,2-dimethylpropane-1,3-diamine, 1,6-hexamethylene diamine, octamethylene diamine, dimeric fatty acid (C36) diamine, 1,2-cyclohexane diamine, 1,4-cyclohexane diamine, 2-methyl cyclohexane-1,3-diamine, 4-methyl cyclohexane-1,3-diamine, 3-(cylohexylamino)propyl amine, 4,4′-dicyclohexylmethane diamine, 2,4′-dicyclohexylmethane diamine, 3,3′-dimethyl-4,4′-dicyclohexylmethane diamine, 3,3′-dimethyl-2,4′-dicyclohexylmethane diamine, isophorone diamine, piperazine, 2-methylpiperazine, 2,5-dimethylpiperazin, 2-Imidazolidinone diamine, 1,2-phenylene diamine, 1,4-phenylene diamine, 4,4′-diamino diphenylmethane, 2,4′-diamino diphenylmethane, 2,6-Diamino-4-phenyltriazine, 2,4-Diamino-6-phenyl-1,3,5-triazine, 3,3-dichlorobenzidene, 4,4′-methylene-bis-(2-chloroaniline), 3,3-dichloro-4,4-diamino diphenylmethane, 4,7,10-trioxatridecane-1,13-diamine, 4,9-dioxadodecane-1,12-diamine, N-[3-(isodecyloxy)propyl]propane-1,3-diamine, sulfonated primary and/or secondary amines, like N-(2-aminiethyl)-2-aminoethanesulfonic acid and there alkali salts, 2,4-diminobenzenesulfonic acid and/or 4,4′-Diaminodiphenylsulfon, hydrazine, monomethylhydrazine (MMH), dihydrazides of dicarboxylic acids such as adipic dihydrazide (ADH), carbodihydrazide (CDH), sebacic acid dihydrazide (SDH), valine dihydrazide (VDH), isophthalic dihydrazide (IDH), icosanedioic acid dihydrazide (LDH) and mixtures thereof.

Preferred chain extension agents are polyamines having at least three amino groups like for example at least two primary amino groups and at least one secondary amino group. Even more preferably, exactly three amino groups are present, more particularly two primary amino groups and one secondary amino group. One preferred polyamine is diethylene triamine.

The chain extension agent is preferably fed in form of an aqueous composition to the aqueous polyurethane-based dispersion being discharged from the high shear dispersion device and rotor/stator unit, respectively. For example, the aqueous composition may be a solution or dispersion of the chain extension agent in water having a concentration of the chain extension agent of between 5 and 20% by weight, based on the composition. Preferably, the feeding of the aqueous composition takes place in a continuous manner. The actually desired concentration of the chain extension agent, quite obviously, may depend on different aspects like mass flow of aqueous polyurethane-based dispersion being discharged from the high shear dispersion device, concentration of the polyurethane-based species in the dispersion, isocyanate content of the polyurethane-based species or mass flow of the composition containing the chain extension agent. In sum, these parameters are adjustable according to individual needs. The continuous feeding of the chain extension agent may be conducted via a T joint in the pipe system. In order to ensure an appropriate mixing, a mixing device like a static mixer may be positioned in the system after the point where the chain extending agent is fed.

Preferably, the molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective agent in the aqueous composition) is greater than 0.8:1, for example from 0.8:1 to 3:1 or 0.9:1 to 2:1.

Thus, in a preferred embodiment the continuous mass flow of the polyurethane-based dispersion being discharged from the high shear dispersion device and the continuous mass flow of the composition comprising the chain extension agent are adjusted in a way that the molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective agent in the aqueous composition) is greater than 0.8:1, for example from 0.8:1 to 3:1 or 0.9:1 to 2:1.

The fact that the chain extension agent is only added after the dispersion has left the high shear dispersion device has the advantage that effective crosslinking triggered by the chain extension agent does not occur within the device and thus avoids potential clogging and blocking processes of the intricate cavity system of the device.

On the other hand, as mentioned earlier, the reaction of isocyanate with water resulting in amino groups and subsequent consumption of further isocyanate need to be considered. The person skilled in the art may choose and adapt appropriate conditions to ensure that addition of the chain extension agents is conducted at a point in time where an effective reaction between isocyanate and chain extension agent is still guaranteed.

In a preferred embodiment, the duration between the point in time at which the dispersion is leaving the high shear dispersion device and the point in time of feeding/adding the chain extension agent (in the following “residence time”) is not more than 30 seconds. Preferably, the residence time is not more than 20 seconds or even not more than 10 seconds or 5 seconds. Calculation of the residence time (which is an average statistical number) may be conducted under consideration of the mass flow of the aqueous polyurethane-based dispersion continuously discharged from the rotor/stator unit (and thus high shear dispersion device) and the volume which the polyurethane-based dispersion has to pass via the respective pipe system before the chain extending agent is fed/added (volume calculated, for example, via inner diameter of the pipe system and distance between the point where the aqueous polyurethane-based dispersion leaves the high shear dispersion device and the point where the chain extender agent is added). More specifically, the calculation may be conducted via the parameters mass flow, inner diameter of the pipe system, length of relevant pipe system (exit from high shear dispersion device and the point where the chain extender agent is added) and density of the aqueous dispersion exiting the high shear dispersion device (for the calculation, the density at a temperature of 60 °C was taken).

From the above follows that the residence time, therefore, is the average time which a part of the aqueous dispersion and thus polyurethane species is in contact with water, but without the chain extension agent.

Step (6) of the process of the invention, i.e., feeding the chain extension agent and thus starting reaction of in particular amino groups of this chain extension agent with isocyanate, ultimately lead to production of an aqueous polyurethane-polyurea dispersion. The dispersion may be collected in a holding vessel, for example. It of course is also possible to directly convey the dispersion via pipe systems to further processes and respective plant setups, like processes and setups for producing coating materials.

The finally resulting aqueous polyurethane-polyurea dispersion is characterized in that the polyurethane-polyurea particles present in the dispersion have an average particle size (volume-based mean diameter) of 50 nm to 500 nm, more preferably, 50 to 300 nm and most preferably 50 to 250 nm (measured via photon correlation spectroscopy as described in the example section).

A further aspect of the invention is an aqueous polyurethane-polyurea dispersion comprising polyurethane-polyurea particles having a volume-based mean diameter of 50 to 500 nm. The dispersion further is characterized by an MEQ base of 0.125 to 0.625 mmol/g (based on solids content). Also, it is essential that the production of the dispersion involves a neutralization step with at least one alkali metal hydroxide as neutralization agent.

The aqueous polyurethane-polyurea dispersion preferably has a gel fraction of at least 60%, more preferably of at least 70%, especially preferably of at least 80%. The gel fraction may therefore amount to up to 100% or approximately 100%, as for example 99% or 98%. In such a case, then, the entire—or almost the entire—polyurethane-polyurea polymer is present in the form of crosslinked particles.

Therefore, the dispersions preferably are microgel dispersions, i.e. polymer dispersions in which on the one hand the polymer is present in the form of comparatively small particles, or microparticles, and on the other hand the polymer particles are at least partly intramolecularly crosslinked. As is known, such microgel dispersions have great advantages on versatile properties of coating materials like, for example, automotive coating compositions like pigmented automotive coating compositions. Such properties are, for example, excellent optical and mechanical properties of cured coatings prepared by such coating materials, on the one hand, and a high solids content and good storage stability of aqueous coating materials, in particular pigmented coating materials like basecoat materials, on the other.

The fraction of the polyurethane-polyurea polymer in the aqueous dispersion is preferably 25 to 55 wt %, preferably 30 to 50 wt %, more preferably 35 to 45 wt %, based in each case on the total amount of the aqueous dispersion. Therefore, the solids content of the aqueous dispersion, quite obviously, preferably, is 25 to 55%, preferably 30 to 50%, more preferably 35 to 45%. The fraction of water in the dispersion is preferably 40 to 70 wt %, preferably 45 to 65 wt %, more preferably 50 to 60 wt %, based in each case on the total amount of the dispersion.

The aqueous dispersion consists preferably to an extent of at least 90 wt % of the polyurethane-polyurea polymer and water (calculated as sum of fraction of water and solids content of the dispersion (in wt.-%)).

Accordingly, the content of organic solvents in the aqueous dispersion may be very low and preferably is below 10 wt %, based on the total weight of the dispersion. Specifically, and also as pointed out above, this very low content of organic solvents may be achieved without any need of a final distillation process for removing such organic solvents. Accordingly, the process of the invention preferably does not include such a distillation step (even if, of course, this is not excluded). Also, in case that such a distillation step is conducted, during this step normally only a minor fraction of organic solvent needs to be removed, quite obviously. Therefore, in case a distillation step is conducted, this step is comparably low energy and/or time consuming compared to what is known from the prior art.

In a preferred embodiment, the process of the invention thus does not include a distillation step or the process of the invention includes a distillation step in which organic solvents are distilled of making up not more than a fraction of 5 wt % of the aqueous dispersion before distillation, whereby the process still results in an aqueous polyurethane-polyurea dispersion having a content of organic solvents of below 10 wt %.

The invention is illustrated below using examples.

### EXAMPLES

### 1. Solids Content

Unless otherwise indicated, the solids content, also referred to as solid fraction hereinafter, was determined in accordance with DIN EN ISO 3251 at 130 °C; 60 min, initial mass 1.0 g. If reference is made in the context of the present invention to an official standard, this of course means the version of the standard that was current on the filing date, or, if no current version exists at that date, then the last current version.

### 2. Isocyanate Content

The isocyanate content, also referred to below as NCO content, was determined by adding an excess of a 2% strength N,N-dibutylamine solution in xylene to a homogeneous solution of the samples in acetone/N-ethylpyrrolidone (1:1 vol %), by potentiometric back-titration of the amine excess with 0.1 N hydrochloric acid, in a method based on DIN EN ISO 3251, DIN EN ISO 11909, and DIN EN ISO 14896. The NCO content of the polymer, based on solids, can be calculated back via the fraction of a polymer (solids content) in solution.

### 3. Hydroxyl Number

The hydroxyl number was determined on the basis of R.-P. Krüger, R. Gnauck and R. Algeier, Plaste und Kautschuk, 20, 274 (1982), by means of acetic anhydride in the presence of 4-dimethylaminopyridine as a catalyst in a tetrahydrofuran (THF)/dimethylformamide (DMF) solution at room temperature, by fully hydrolyzing the excess of acetic anthydride remaining after acetylation and conducting a potentiometric back-titration of the acetic acid with alcoholic potassium hydroxide solution. Acetylation times of 60 minutes were sufficient in all cases to guarantee complete conversion.

### 4. Acid Number

The acid number was determined on the basis of DIN EN ISO 2114 in homogeneous solution of tetrahydrofuran (THF)/water (9 parts by volume of THF and 1 part by volume of distilled water) with ethanolic potassium hydroxide solution. Based on the determined acid number the MEQ acid (in meq/g solids content) can be calculated as “MEQ acid=acid number/56.105”.

### 5. MEQ Base

The MEQ base (in meq/g solids content) was determined on the basis of DIN EN ISO 15880 in homogeneous solution of tetrahydrofuran (THF)/water (9 parts by volume of THF and 1 part by volume of distilled water) by neutralization with hydrochloric acid.

### 6. Degree of Neutralization

The degree of neutralization of a component was calculated from the amount of substance of the carboxylic acid groups present in the component (determined via the acid number) and the amount of neutralizing groups (i.e. base) of the neutralizing agent used. The degree of neutralization can also be calculated as

“Degree of neutralization=(MEQ base/MEQ acid)*100%”.

### 7. Solvent Content

The amount of an organic solvent in a mixture, if not determined/determinable by means of weighting-in during production of such a mixture, was determined by means of gas chromatography (Agilent 7890A, 50 m silica capillary column with polyethylene glycol phase or 50 m silica capillary column with polydimethylsiloxane phase, helium carrier gas, 250 °C split injector, 40-220 °C oven temperature, flame ionization detector, 275 °C detector temperature, n-propyl glycol as internal standard).

### 8. Number-Average Molecular Weight

The number-average molar mass (Mn) was determined, unless otherwise indicated, by means of a vapor pressure osmometer (VPO) 10.00 (from Knauer) on concentration series in toluene at 50 °C with benzophenone as calibration substance for the determination of the experimental calibration constant of the instrument used, by the method of E. Schröder, G. Müller, K. F. Arndt, “Leitfaden der Polymercharakterisierung” [Principles of polymer characterization], Akademie-Verlag, Berlin, pp. 47-54, 1982.

### 9. Particle Size

Depending on the (expected) magnitude, the particle size was determined by laser diffraction or photon correlation spectroscopy (PCS). The defining parameter for describing the particle size according to the present invention is the volume-based mean diameter (also called “D[4.3]/De Broucker mean” in the context of laser diffraction). For the sake of completeness, also further parameters were determined (cf. below).

Thereby, for all samples having a volume-based mean diameter of at least 600 nm measured by laser diffraction, this method was taken for describing/defining the particle size. For all samples having a volume-based mean diameter of below 600 nm measured by laser diffraction, a further measurement of the volume-based mean diameter via PCS was conducted, meaning that this method was taken for describing/defining the particle size. Reason is that PCS is known to give reliable measurement results in the lower particle size range, while laser diffraction is deemed optimal for a respectively higher particle size range.

### 9.1 Laser Diffraction

Values describing the particle size were determined by laser diffraction in accordance with ISO 13220, using a Mastersizer 2000 particle size measuring instrument (from Malvern Instruments). The instrument operates with a red light source (max. 4 mW He—Ne, 633 nm) and a blue light source (max. 0.3 mW LED, 470 nm). In order to set the concentration range appropriate for the measurement, the sample was diluted with particle-free, deionized water as dispersing medium (refractive index: 1.33), the shading of light was set at between 3% and 15%, depending on each sample, and measurement took place in the “Hydro 2000G” dispersing unit (from Malvern Instruments). In each case, six measurements were performed at stirring speeds of 2000 1/min and 3000 1/min, and the measurements were repeated on a second, freshly prepared sample. The particle size measuring instrument was verified using particle size standards in the range from 0.2 to 190 μm. The calculation of the parameters describing the particle size (cf. below) was conducted using the Malvern Instruments Software (Version 5.60) by means of MIE approximation.

The following values were determined:
(D[2,3]) Arithmetic mean of the surface average values (Sauter diameter) of the individual preparations
(D[4.3]) Arithmetic mean of the volume average values (De Broucker mean, volume-based mean diameter) of the individual preparations
d(0.1) 10% of the total volume of particles have smaller diameter than the value
d(0.5) 50% of the total volume of particles have smaller diameter than the value
d(0.9) 90% of the total volume of particles have smaller diameter than the value

### 9.2. PCS

Employed specifically for the measurement was a Malvern Nano S90 (from Malvern Instruments) at 25±1 °C. The instrument is equipped with a 4 mW He—Ne laser at 633 nm. The samples (i.e. aqueous dispersions) were diluted with particle-free, deionized water as dispersing medium, before being subjected to measurement in a 1 ml polystyrene cell at suitable scattering intensity. Evaluation took place using a digital correlator, with the assistance of the Zetasizer analysis software, version 6.32 (from Malvern Instruments). Measurement took place five times, and the measurements were repeated on a second, freshly prepared sample. The standard deviation of a 5-fold determination was ≤4%. The maximum deviation of the volume-based mean diameters of five individual measurements was ±15%. The reported particle size is the arithmetic mean of the volume-based mean diameters measured for the individual preparations. Verification was carried out using polystyrene standards having certified particle sizes between 50 to 3000 nm.

### 10. Gel Fraction

The gel fraction of the polyurethane-polyurea particles (microgel particles) present in the aqueous dispersions is determined gravimetrically in the context of the present invention. Here, first of all, the polymer present was isolated from a sample of an aqueous dispersion (initial mass 1.0 g) by freeze-drying. Following determination of the solidification temperature—the temperature after which the electrical resistance of the sample shows no further change when the temperature is lowered further—the fully frozen sample underwent its main drying, customarily in the drying vacuum pressure range between 5 mbar and 0.05 mbar, at a drying temperature lower by 10 °C than the solidification temperature. By graduated increase in the temperature of the heated surfaces beneath the polymer to 25 °C, rapid freeze-drying of the polymers was achieved; after a drying time of typically 12 hours, the amount of isolated polymer (solid fraction, determined by the freeze-drying) was constant and no longer underwent any change even on prolonged freeze-drying. Subsequent drying at a temperature of the surface beneath the polymer of 30 °C with the ambient pressure reduced to maximum (typically between 0.05 and 0.03 mbar) produced optimum drying of the polymer.

The isolated polymer was subsequently sintered in a forced air oven at 130 °C for one minute and thereafter extracted for 24 hours at 25 °C in an excess of tetrahydrofuran (ratio of tetrahydrofuran to solid fraction=300:1). The insoluble fraction of the isolated polymer (gel fraction) was then separated off on a suitable frit, dried in a forced air oven at 50 °C for 4 hours, and subsequently reweighed.

It was further ascertained that at the sintering temperature of 130 °C, with variation in the sintering times between one minute and twenty minutes, the gel fraction found for the microgel particles is independent of sintering time. It can therefore be ruled out that crosslinking reactions subsequent to the isolation of the polymeric solid increase the gel fraction further.

The gel fraction determined in this way in accordance with the invention is also called gel fraction (freeze-dried).

In parallel, a gel fraction, hereinafter also called gel fraction (130 °C), was determined gravimetrically, by isolating a polymer sample from aqueous dispersion (initial mass 1.0 g) at 130 °C for 60 minutes (solids content). The mass of the polymer was ascertained, after which the polymer was extracted in an excess of tetrahydrofuran at 25 °C, in analogy to the procedure described above, for 24 hours, after which the insoluble fraction (gel fraction) was separated off, dried, and reweighed.

### Example P1 Preparation of a Polyurethane Prepolymer (a) and an Organic Phase (I)

In a reaction vessel equipped with stirrer, internal thermometer, reflux condenser, and electrical heating, 6110.6 parts by weight of a linear polyester polyol and 289.9 parts by weight of dimethylolpropionic acid (from GEO Speciality Chemicals) were dissolved under nitrogen in 650.0 parts by weight of methylisobutylketone (from BASF SE) and 650.0 parts by weight of dipropylenglycol dimethylether (Proglyme®, from BASF SE). The linear polyester diol was prepared beforehand from dimerized fatty acid (Radiacid® 0971, from Oleon), isophthalic acid (from BP Chemicals), and hexane-1,6-diol (from BASF SE) (weight ratio of the starting materials:dimeric fatty acid to isophthalic acid to hexane-1,6-diol=54.32:16.08:29.60), and had a hydroxyl number of 75 mg KOH/g on solids content, a water content according to Karl-Fischer of 0.02 wt.-%, an acid number of 3.5 mg KOH/g on solids content, a calculated number-average molar mass of 1418 g/mole, and a number-average molar mass as determined via vapor pressure osmometry of 1390 g/mole. Added in succession to the resulting solution at 30 °C were 2269.9 parts by weight of dicyclohexylmethane 4,4′-diisocyanate (Desmodur® W, from Bayer MaterialScience) with an isocyanate content of 32.0 wt-%, and 10.4 parts by weight of dibutyltin dilaurate (from Merck). The mixture was then heated to 80 °C with stirring. Stirring was continued at this temperature until the isocyanate content of the solution was constant at 2.00% by weight.

Once it was determined that the isocyanate level was constant, the polyurethane prepolymer and the respective organic phase (I) was kept at 82 °C under nitrogen and was further processed within 12 hours. Within this time the isocyanate level and the viscosity remained constant.

The characteristics of the prepolymer/the organic phase (I) were as follows:
Solids content (130 °C, 60 min, 1 g): 87.1 wt.-%
NCO content (reactor) 2.00 wt.-%
Dipropylene glycol dimethylether content (GC): 6.5 wt.-%
Methyl isobutyl ketone content (GC): 6.4 wt.-%
Viscosity (80 °C, rotational viscosimeter,
   shear rate=10/s): 17.6 Pa·s
Acid number (on solids) 17.1 mg KOH/g
Number average molecular weight (VPO) 3500 g/mol

### Example D1 Preparation of an Aqueous Polyurethane-Polyurea Dispersion

The organic phase (I) P1 was loaded into an addition tank at 82 °C under 5.5 bar nitrogen overpressure and was then fed continuously at a mass flow of 7.671 kg per hour through a stainless-steel pipe into a high shear dispersion device comprising a rotor/stator unit via a gear pump. The transfer tube was insulated and heated to 82 °C. In a second addition tank, an aqueous phase (II) consisting of a 0.639 wt.-% sodium hydroxide (Fa. Merck) solution in deionized water was provided at 5 °C and continuously fed through a separate pipe with a mass flow of 8.284 kg per hour into said high shear dispersion device comprising a rotor/stator unit by using an eccentric screw pump. Both dosages were stopped after 23 minutes and 28 seconds. By that time, 3000.0 g of organic phase (I) and 3239.9 g of aqueous phase (II) were supplied. During the entire process, the mass flows of the two phases as mentioned above ensured a degree of neutralization of 65% (first neutralization step).

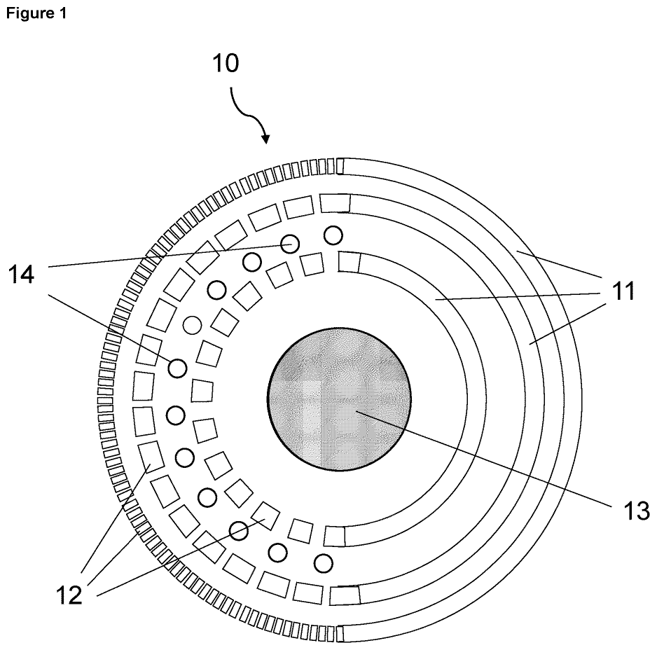

The two streams were supplied in parallel (i.e. simultaneously) and then combined within and not before reaching the rotor/stator unit. More specifically, the two streams and thus phases were combined in the stator subunit as principally shown in FIG. 1. Thereby, the aqueous phase (II) was supplied via a centrically located first inlet (13) and the organic phase (I) was fed in form of multiple sub feed streams via multiple second inlets (14). The high shear dispersion device was based on a Cavitron CD 1010 rotor/stator dispenser from Hagen & Funke. Within the setup of this example, the cylindrical stator subunit with centric inlet (13) further had 24 drill holes with an inner diameter of 2 mm (i.e. multiple inlets (14)) arranged in form of a circle and having uniform distances to each other. The stator subunit was equipped with three stator sets of teeth (11) (inner diameters: I-35.2 mm, II-52.5 mm, III-63.5 mm) having different numbers of teeth (12) (I-24, II-34, III-160), whereby the drill holes were positioned between two stator sets of teeth as shown in FIG. 1 (i.e. between the set with the smallest diameter and the set with the middle diameter). The cylindric rotor subunit was equipped with four rotor sets of teeth (21) having a different number of teeth (22) (I-12, II-28, III-70, IV-160). The rotor sets of teeth were positioned alternatingly to the stator sets of teeth as in principle shown in FIG. 3 and were rotatable at a maximum rotation speed of 12000 rpm.

By passing the inlets and then grooves between the teeth of the partly rotating sets of teeth of stator and rotor, the high viscous organic-based phase (I) and low viscous aqueous phase were intensively dispersed under high shear. The resulting dispersion was discharged from an outlet located beyond the outmost rotor set of teeth. For reducing the temperature of the discharging dispersion, the rotor/stator unit was completely jacketed and internally cooled, leading to a temperature of said discharging dispersion of approximately 55 °C.

Chain extension was accomplished via a T joint injector. The aqueous dispersion discharged from the high shear dispersion device was continuously passed through a respective pipe system connected to one arm of a T joint, while the chain extension agent was continuously fed via a second arm of the T joint. More specifically, the chain extension agent was continuously fed as an aqueous solution (8.0 wt.-% of diethylene triamine in deionized water) with a mass flow of 0.971 kg per hour by using a double piston pump (again for a duration of 23 minutes and 28 seconds, meaning that a total of 379.7 g of aqueous amine solution was supplied). Downstream of the T joint, a static mixer has been used for effectively mixing the polyurethan dispersion with the chain extension amine. During the entire process, the mass flows of the aqueous dispersion discharged from the high shear dispersion device and the diethylene triamine solution ensured a molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective diethylene triamine in the aqueous solution) of 1.62:1. The duration between the point in time at which the aqueous dispersion was leaving the high shear dispersion device and the point in time of feeding/adding the chain extension agent (residence time) was calculated to 6.7 s.

In the following, different relevant parameters of the above-described process are once more summarized. Also, characteristics of the produced aqueous polyurethane-polyurea dispersion D1 are listed.
Mass flow organic phase (I) 7.671 kg per hour
Mass flow aqueous phase (II) 8.284 kg per hour
Mass flow aqueous solution of chain extension agent 0.971 kg per hour
Mass flow of polyurethane-polyurea dispersion (total) 16.926 kg per hour
Inner diameter of outlet pipe from high shear dispersion device to 12 mm
injection point of chain extension agent (T joint)
Distance from exit from high shear dispersion device to point 27.4 cm
of addition of chain extension agent (T joint)
Density of aqueous dispersion discharged from 1.024 g/cm³
the high shear dispersion device (60 °C)
Residence time 6.7 s
Rotor speed 12000 rpm
Temperature organic phase (I) at inlet high shear dispersion device 82 °C
Temperature of aqueous dispersion discharged from 54 °C the high shear dispersion device when reaching T joint
Solids content (130 °C, 60 min, 1 g): 40.2 wt.-%
Dipropylenglycol dimethylether (GC): 3.0 wt.-%
Methyl isobutyl ketone-Gehalt (GC): 2.9 wt.-%
Viscosity (23 °C, original, rotational viscosimeter,
   shear rate=1000/s): 16 mPa·s
Acid number 17.6 mg KOH/g
   solids content
MEQ Base 0.257 mmol/g
   solids content
Degree of neutralization 82%
pH (23 °C) 7.7
Parameters on particle size (Photon correlation spectroscopy):
   Volume average particle size 181 nm
   (i.e. volume-based mean diameter)
   z-average particle size 177 nm
Gel fraction (130 °C) 98.8 wt.-%
Gel fraction (freeze-dried) 98.5 wt.-%

The produced aqueous polyurethane-polyurea dispersion D1 had an excellent storage stability. The dispersion was well suitable for applications in, for example, basecoat compositions like automotive basecoat compositions. Thus, the dispersion readily serves for providing basecoat compositions and also multicoat paint systems comprising a basecoat film produced by means of such a basecoat composition. Specifically, the dispersion led to a significantly improved yellowing behavior (i.e. coatings like multicoat paint systems comprising coating layers based on aqueous basecoat compositions comprising the dispersion show a very low tendency to successive yellowing, ultimately leading to an improved optical quality level).

### Example D2 Preparation of an Aqueous Polyurethane-Polyurea Dispersion

Like in example D1, the preparation of the aqueous polyurethane-polyurea dispersion D2 again involves the same overall general procedure as for Example D1 in terms of properties of the high shear dispersion device. Deviations in particular lie in the selection of the neutralizing agent.

More specifically, the organic phase (I) P1 was loaded into an addition tank at 82 °C under 5.5 bar nitrogen overpressure and was then fed continuously at a mass flow of 7.004 kg per hour through a stainless-steel pipe into a high shear dispersion device comprising a rotor/stator unit via a gear pump. The transfer tube was insulated and heated to 82 °C. In a second addition tank, an aqueous phase (II) consisting of a 0.383 wt.-% lithium hydroxide (from Merck) solution in deionized water was provided at 5 °C and continuously fed through a separate pipe with a mass flow of 7.554 kg per hour into said high shear dispersion device comprising a rotor/stator unit by using an eccentric screw pump. Both dosages were stopped after 25 minutes and 42 seconds. By that time, 3000.0 g of organic phase (I) and 3235.9 g of aqueous phase (II) were supplied. During the entire process, the mass flows of the two phases as mentioned above ensured a degree of neutralization of 65% (first neutralization step).

The two streams were supplied, combined and dispersed as described in example D1. For reducing the temperature of the discharging dispersion, the rotor/stator unit again was completely jacketed and internally cooled.

Likewise, chain extension was again accomplished via a T joint injector. The aqueous dispersion discharged from the high shear dispersion device was continuously passed through a respective pipe system connected to one arm of a T joint, while the chain extension agent was continuously fed via a second arm of the T joint. More specifically, the chain extension agent was continuously fed as an aqueous solution (8.0 wt.-% of diethylene triamine in deionized water) with a mass flow of 0.887 kg per hour by using a double piston pump (for a duration of 25 minutes and 42 seconds, meaning that a total of 379.7 g of aqueous amine solution was supplied). Downstream of the T joint, again a static mixer has been used for effectively mixing the polyurethan dispersion with the chain extension amine. The molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective diethylene triamine in the aqueous solution) again was kept at 1.62:1. The duration between the point in time at which the aqueous dispersion was leaving the high shear dispersion device and the point in time of feeding/adding the chain extension agent (residence time) was calculated to 7.4 s.

The continuously produced aqueous polyurethane-polyurea dispersion was collected in a collecting vessel and cooled down to 23 °C. 32.4 g of a 10 wt.-% lithium hydroxide solution in deionized water were added under stirring to result in a degree of neutralization of 82% (second neutralization step). A white, stable, solids-rich, low-viscosity dispersion containing crosslinked particles was obtained, and showed no sedimentation within 12 months.

In the following, different relevant parameters of the above-described process are once more summarized. Also, characteristics of the produced aqueous polyurethane-polyurea dispersion D2 are listed.
Mass flow organic phase (I) 7.004 kg per hour
Mass flow aqueous phase (II) 7.554 kg per hour
0.887 kg per hour Mass flow aqueous solution of chain extension agent
Mass flow of polyurethane-polyurea dispersion (total) 15.445 kg per hour
Inner diameter of outlet pipe from high shear dispersion device to 12 mm injection point of chain extension agent (T joint)
Distance from exit from high shear dispersion device to point 27.4 cm of addition of chain extension agent (T joint)
Density of aqueous dispersion discharged from 1.024 g/cm³ the high shear dispersion device (60 °C)
Residence time 7.4 s
Rotor speed 12000 rpm
Temperature organic phase (I) at inlet high shear dispersion device 82 °C
Temperature of aqueous dispersion discharged from 55 °C the high shear dispersion device when reaching T joint
Solids content (130 °C, 60 min, 1 g): 40.0 wt.-%
Dipropylenglycol dimethylether (GC): 2.9 wt.-%
Methyl isobutyl ketone-Gehalt (GC): 2.9 wt.-%
Viscosity (23 °C, original, rotational viscosimeter,
   shear rate=1000/s): 21 mPa·s
Acid number 18.5 mg KOH/g
   solids content
MEQ Base 0.264 mmol/g
   solids content
Degree of neutralization 80%
PH (23 °C) 7.6
Parameters on particle size (Photon correlation spectroscopy):
   Volume average particle size 174 nm
   (i.e. volume-based mean diameter)
   z-average particle size 178 nm
Gel fraction (130 °C) 96.9 wt.-%
Gel fraction (freeze-dried) 96.0 wt.-%

The produced aqueous polyurethane-polyurea dispersion D2 had an excellent storage stability. The dispersion was well suitable for applications in, for example, basecoat compositions like automotive basecoat compositions. Thus, the dispersion readily serves for providing basecoat compositions and also multicoat paint systems comprising a basecoat film produced by means of such a basecoat composition. Specifically, the dispersion led to a significantly improved yellowing behavior (i.e. coatings like multicoat paint systems comprising coating layers based on aqueous basecoat compositions comprising the dispersion show a very low tendency to successive yellowing, ultimately leading to an improved optical quality level).

### Example V1 Preparation of an Aqueous Polyurethane-Polyurea Dispersion

Like in example D1, the preparation of the aqueous polyurethane-polyurea dispersion V1 again involves the same overall general procedure as for Example D1 in terms of properties of the high shear dispersion device (drill holes etc.). Deviations in particular lie in the selection of the neutralizing agent.

The organic phase (I) P1 was loaded into an addition tank at 82 °C under 5.0 bar nitrogen overpressure and was then fed continuously at a mass flow of 7.600 kg per hour through a stainless-steel pipe into a high shear dispersion device comprising a rotor/stator unit via a gear pump. The transfer tube was insulated and heated to 82 °C. In a second addition tank, an aqueous phase (II) consisting of a 2.056 wt.-% triethylamine TEA (from BASF SE) solution in deionized water was provided at 5 °C and continuously fed through a separate pipe with a mass flow of 8.341 kg per hour into said high shear dispersion device comprising a rotor/stator unit by using an eccentric screw pump. Both dosages were stopped after 23 minutes and 41 seconds. By that time, 3000.0 g of organic phase (I) and 3292.2 g of aqueous phase (II) were supplied. During the entire process, the mass flows of the two phases as mentioned above ensured a degree of neutralization of 84%.

The two streams were supplied, combined and dispersed as described in example D1. For reducing the temperature of the discharging dispersion, the rotor/stator unit again was completely jacketed and internally cooled.

Chain extension was again accomplished via a T joint injector. The aqueous dispersion discharged from the high shear dispersion device was continuously passed through a respective pipe system connected to one arm of a T joint, while the chain extension agent was continuously fed via a second arm of the T joint. More specifically, the chain extension agent was continuously fed as an aqueous solution (8.0 wt.-% of diethylene triamine in deionized water) with a mass flow of 0.962 kg per hour by using a double piston pump (again for a duration of 23 minutes and 41 seconds, meaning that a total of 379.7 g of aqueous amine solution was supplied). Downstream of the T joint, a static mixer has been used for effectively mixing the polyurethan dispersion with the chain extension amine. During the entire process, the mass flows of the aqueous dispersion discharged from the high shear dispersion device and the diethylene triamine solution ensured a molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective diethylene triamine in the aqueous solution) of 1.62:1. The duration between the point in time at which the aqueous dispersion was leaving the high shear dispersion device and the point in time of feeding/adding the chain extension agent (residence time) was calculated to 6.8 s.

In the following, different relevant parameters of the above-described process are once more summarized:
Mass flow organic phase (I) 7.600 kg per hour
Mass flow aqueous phase (II) 8.341 kg per hour
Mass flow aqueous solution of chain extension agent 0.962 kg per hour
Mass flow of polyurethane-polyurea dispersion (total) 16.903 kg per hour
Inner diameter of outlet pipe from high shear dispersion device to 12 mm
injection point of chain extension agent (T joint)
Distance from exit from high shear dispersion device to point 27.4 cm of addition of chain extension agent (T joint)
Density of aqueous dispersion discharged from 1.024 g/cm³
the high shear dispersion device (60 °C)
Residence time 6.8 s
Rotor speed 12000 rpm
Temperature organic phase (I) at inlet high shear dispersion device 82 °C
Temperature of aqueous dispersion discharged from 50 °C
the high shear dispersion device when reaching T joint

The continuously produced aqueous polyurethane-polyurea dispersion was collected in a collecting vessel and cooled down to 23 °C. A white, stable, solids-rich, low-viscosity dispersion containing crosslinked particles was obtained, and showed no sedimentation within 6 months.

The characteristics of the produced aqueous polyurethane-polyurea dispersion V1 were as follows:
Solids content (130 °C, 60 min, 1 g): 40.1 wt.-%
Dipropylenglycol dimethylether (GC): 3.0 wt.-%
Methyl isobutyl ketone-Gehalt (GC): 2.9 wt.-%
Viscosity (23 °C, original, rotational viscosimeter,
   shear rate=1000/s): 39 mPa·s
Acid number 17.1 mg KOH/g
   solids content
MEQ Base 0.256 mmol/g
   solids content
Degree of neutralization 84%
pH (23 °C) 7.6
Parameters on particle size (Laser diffraction):
   d(0,1) 0.5 μm
   D[3,2] 0.7 μm
   d(0,5) 0.8 μm
   D[4,3] (i.e. volume-based mean diameter) 1.1 μm
   d(0,9) 1.5 μm
Gel fraction (130 °C) 88.9 wt.-%
Gel fraction (freeze-dried) 87.3 wt.-%

### Example V2 Preparation of an Aqueous Polyurethane-Polyurea Dispersion

Like in example D1, the preparation of the aqueous polyurethane-polyurea dispersion V2 again involves the same overall general procedure as for Example D1 in terms of properties of the high shear dispersion device (drill holes etc.). Deviations in particular lie in the selection of the neutralizing agent.

More specifically, the organic phase (I) P1 was loaded into an addition tank at 82 °C under 5.0 bar nitrogen overpressure and was then fed continuously at a mass flow of 7.171 kg per hour through a stainless-steel pipe into a high shear dispersion device comprising a rotor/stator unit via a gear pump. The transfer tube was insulated and heated to 82 °C.

In a second addition tank, an aqueous phase (II) consisting of a 2.197 wt.-% triethylene diamine TEDA (1,4-diazabicylo[2.2.2]octane, from BASF SE) solution in deionized water was provided at 5 °C and continuously fed through a separate pipe with a mass flow of 8,166 kg per hour into said high shear dispersion device comprising a rotor/stator unit by using an eccentric screw pump. Both dosages were stopped after 25 minutes and 6 seconds. By that time, 3000.0 g of organic phase (I) and 3416.3 g of aqueous phase (II) were supplied. During the entire process, the mass flows of the two phases as mentioned above ensured a degree of neutralization of 84%.

The two streams were supplied, combined and dispersed as described in example D1. For reducing the temperature of the discharging dispersion, the rotor/stator unit again was completely jacketed and internally cooled.

Likewise, chain extension was again accomplished via a T joint injector. The aqueous dispersion discharged from the high shear dispersion device was continuously passed through a respective pipe system connected to one arm of a T joint, while the chain extension agent was continuously fed via a second arm of the T joint. More specifically, the chain extension agent was continuously fed as an aqueous solution (8.0 wt.-% of diethylene triamine in deionized water) with a mass flow of 0.908 kg per hour by using a double piston pump (again for a duration of 25 minutes and 6 seconds, meaning that a total of 379.7 g of aqueous amine solution was supplied). Downstream of the T joint, a static mixer has been used for effectively mixing the polyurethan dispersion with the chain extension amine. During the entire process, the mass flows of the aqueous dispersion discharged from the high shear dispersion device and the diethylene triamine solution ensured a molar ratio of isocyanate groups of the polyurethane-based dispersion (calculated as isocyanate groups contained in the prepolymer of the organic phase (I)) and the sum of primary and secondary amino groups of the chain extension agent (calculated from the concentration of the respective diethylene triamine in the aqueous solution) of 1.62:1. The duration between the point in time at which the aqueous dispersion was leaving the high shear dispersion device and the point in time of feeding/adding the chain extension agent (residence time) was calculated to 7.0 s.

In the following, different relevant parameters of the above-described process are once more summarized:
Mass flow organic phase (I) 7.171 kg per hour
Mass flow aqueous phase (II) 8.166 kg per hour
Mass flow aqueous solution of chain extension agent 0.908 kg per hour
Mass flow of polyurethane-polyurea dispersion (total) 16.245 kg per hour
Inner diameter of outlet pipe from high shear dispersion device to 12 mm
injection point of chain extension agent (T joint)
Distance from exit from high shear dispersion device to point 27.4 cm
of addition of chain extension agent (T joint)
Density of aqueous dispersion discharged from 1.024 g/cm³
the high shear dispersion device (60 °C)
Residence time 7.0 s
Rotor speed 12000 rpm
Temperature organic phase (I) at inlet high shear dispersion device 82 °C
Temperature of aqueous dispersion discharged from
the high shear dispersion device when reaching T joint 52 °C.

The continuously produced aqueous polyurethane-polyurea dispersion was collected in a collecting vessel and cooled down to 23 °C. A white, stable, solids-rich, low-viscosity dispersion containing crosslinked particles was obtained, and showed no sedimentation within 6 months.

The characteristics of the produced aqueous polyurethane-polyurea dispersion V2 were as follows:
Solids content (130 °C, 60 min, 1 g): 39.8 wt.-%
Dipropylenglycol dimethylether (GC): 2.9 wt.-%
Methyl isobutyl ketone-Gehalt (GC): 2.9 wt.-%
Viscosity (23 °C, original, rotational viscosimeter,
   shear rate=1000/s): 14 mPa·s
Acid number 17.5 mg KOH/g
   solids content
MEQ Base 0.259 mmol/g
   solids content
83% Degree of neutralization
pH (23 °C) 7.4
Parameters on particle size (Photon correlation spectroscopy):
   540 nm Volume average particle size 540 nm
   (i.e. volume-based mean diameter)
   z-average particle size 666 nm
Gel fraction (130 °C) 90.3 wt.-%
Gel fraction (freeze-dried) 87.7 wt.-%

The above prepared dispersions were used to prepare a binder yellowing test composition BYTC. These comprise the dispersion and thus polyurethane-polyurea polymer, water and low parts of Na—Li—Mg-silicate clay with polypropylene glycol.

At first, wet films of the BYTC were applied to glass plates or white primer coated aluminum panels by using a 150 Micrometer or 250 Micrometer doctor blade. The wet films were dried 10 min at 60 °C and baked 60 min at 160 °C (overbaking test at 160 °C). The non-pigmented films are transparent and contain the polymer from dispersion and additional low levels of clay and polypropylene glycol only.

The yellowness index YI of the baked films (one-layer) on glass plates was determined with a spectrophotometer in transmission. In case of white primer coated Al panels, the b* values of the baked BYTC (two-layers) were measured with a spectrophotometer in reflection and compared to the reference with triethylamine neutralization (V1). Negative values of delta b* mean that the color is more bluish, while positive values stand for more yellowish color as the reference and indicates yellowing.

Table 1 summarizes the respective results and data.

TABLE 1

| | | | D1 | D2 | V1 | V2 |
|---|---|---|---|---|---|---|
| Neutralization | | | NaOH | LiOH | TEA | TEDA |
| Dispersion | | | | | | |
| Solids (130 °C, 60 min) | | in wt.-% | 40.2 | 40.0 | 40.1 | 39.8 |
| BYTC (binder yellowing test composition) | | | | | | |
| Dispersion | Input | in g | 60.0 | 60.0 | 60.0 | 60.0 |
| Clay and polypropylene | Input | in g | 58.0 | 57.7 | 57.9 | 57.4 |
| glycol in water ¹⁾ | | | | | | |
| DI water | Input | in g | 2.0 | 1.7 | 1.8 | 1.4 |
| Solid content (total) | calculated | in wt.-% | 23.0 | 23.0 | 23.0 | 23.0 |
| Content clay | calculated | in wt.-% | 1.450 | 1.450 | 1.450 | 1.450 |
| BYTC on glass plate | | | | | | |
| Wet film applicated with a doctor blade | | in μm | 150 | 150 | 150 | 150 |
| for film thickness | | | | | | |
| Film thickness | after baking ²⁾ | in μm | 19 | 18 | 18 | 18 |
| Yellowness index YI ³⁾ | CIE illuminant C ⁴⁾ | | 1.066 | 1.060 | 1.654 | 1.533 |
| | CIE illuminant D65 ⁵⁾ | | 1.055 | 1.049 | 1.640 | 1.519 |
| Wet film applicated with a doctor blade | | in μm | 250 | 250 | 250 | 250 |
| for film thickness | | | | | | |
| Film thickness | after baking ²⁾ | in μm | 30 | 30 | 29 | 30 |
| Yellowness index YI ³⁾ | CIE illuminant C ⁴⁾ | | 2.129 | 2.125 | 2.820 | 2.612 |
| | CIE illuminant D65 ⁵⁾ | | 2.110 | 2.104 | 2.797 | 2.589 |
| BYTC on white primer ⁶⁾ coated Al panel | | | | | | |
| Wet film applicated with a doctor blade | | in μm | 150 | 150 | 150 | 150 |
| for film thickness | | | | | | |
| Film thickness | after baking ²⁾ | in μm | 15 | 14 | 15 | 15 |

| | | | | | |
|---|---|---|---|---|---|
| Delta b* ⁷⁾ | CIE illuminant D65 ⁵⁾ | −1.09 | −1.11 | Reference | −0.22 |
| Delta b* ⁷⁾ | CIE illuminant A ⁸⁾ | −1.06 | −1.08 | Reference | −0.21 |
| Delta b* ⁷⁾ | CIE illuminant TL84 ⁹⁾ | −1.24 | −1.27 | Reference | −0.25 |

¹ Contains 3.0 wt.-% Laponite® RD (from Byk) and 3.0 wt.-% polypropylene glycol 900 (Pluriol® P 900 C from BASF SE) in deionized water.
² Drying at 60 °C, 10 min, and baking at 160 °C, 60 min.
³ Yellowness index YI is calculated from spectrophotometric data that describes the change in color of a test sample from clear or white to yellow. The baked paint systems on glass plates were measured by using a UV-VIS spectrophotometer from Agilent (Cary 5000). The tristimulus values X, Y and Z were determined in the spectral range of 700 to 400 nm. In order to avoid radiation losses due to dispersion at the detector, an integration sphere (Ulbricht globe) (Labshere 110 nm from Varian) was used. In accordance with ASTM E313-15 the yellowness index YI was calculated from the following equation:

YI=100*(CₓX−C_{z}Z)/Y
In the formula, Cx and Cz are coefficients for the viewing angle 10° by using the illumination techniques CIE illuminant C and CIE illuminant D65. CIE illuminant C and D65 represent an average daylight with a color temperature of approximately 6500K.
⁴ CIE illuminant C represents an average daylight with a color temperature of 6774K.
⁵ CIE illuminant D65 represents an average daylight with a color temperature of 6504K.
⁶ White, water-borne BASF primer FU200201 (Frozen white) on Al panel, baked at a panel temperature of 160 °C for 20 min before application of the second layer based on the binder yellowing test composition BYTC with polymers from dispersions D1, D2, V1 and V2.
⁷ The color data of the two-layer coating white primer surfacer (BASF primer Frozen White FU200201) with the second layer based on the binder yellowing test composition BYTC were determined by the use of a Byk Mac I spectrophotometer (from Byk Gardner GmbH). The illuminations were a D65 illumination (observer angle) 10°, an A illumination (observer angle) 10° and a TL84 illumination (observer angle) 10°. By the use of the afore-mentioned instrument the L*, a* and b* values of the two-layer film were determined. The values on the b*-axis of CIELAB color space, extending from blue to yellow, were recorded to characterize the yellowing. Negative values of delta b* mean that the color is more bluish, while positive values stand for more yellowish color. As a shade reference the system with the triethylamine-neutralized polyurea urethane dispersion V1 was used.
⁸ CIE illuminant A represents a conventional incandescent lamp with a color temperature of 2856K.
⁹ CIE illuminant TL84 represents European and Japanese commercial light source (supermarket light) with a color temperature of 4100K.

The inventive dispersions D1 and D2 show a significantly reduced yellowness index YI compared to amine neutralized dispersions. Amon the amine neutralizations, triethylene diamine shows a slightly reduced yellowing compared to triethyl amine.

1. An aqueous polyurethane-polyurea dispersion comprising polyurethane-polyurea particles having a volume-based mean diameter of from 50 to 500 nm, wherein the dispersion is further characterized by an MEQ base of 0.125 to 0.625 meq/g (based on solids content), wherein production of the dispersion involves a neutralization step with at least one alkali metal hydroxide as a neutralization agent.

2. The aqueous polyurethane-polyurea dispersion according to claim 1, wherein the MEQ base is from 0.15 to 0.50 meq/g (based on solids content).

3. The aqueous polyurethane-polyurea dispersion according to claim 1, wherein the degree of neutralization of the aqueous polyurethane-polyurea dispersion is greater than 65%.

4. The aqueous polyurethane-polyurea dispersion according to claim 1, wherein the dispersion consists to an extent of at least 90 wt % of polyurethane-polyurea polymer and water (calculated as sum of fraction of water and solids content of the dispersion (in wt.-%)).

5. A process for continuous production of an aqueous polyurethane-polyurea dispersion comprising polyurethane-polyurea particles having a volume-based mean diameter of from 50 to 500 nm, wherein the dispersion is further characterized by an MEQ base 0.125 to 0.625 meq/g (based on solids content), comprising the following steps:
(1) providing an organic-based phase (I) comprising
(a) at least one acid-functional polyurethane prepolymer containing isocyanate groups, and (b) from 0 to 20% by weight, based on the total weight of the organic-based phase (I), of at least one organic solvent,
(2) providing an aqueous phase (II),
(3) continuously feeding both the organic-based phase (I) and the aqueous phase (II) into a high shear dispersion device comprising a rotor/stator unit,
(3.1) wherein the organic-based phase (I) and the aqueous phase (II) are brought into contact within and not before reaching the rotor/stator unit, and
(3.2) wherein the organic phase (I) is fed in form of multiple sub feed streams via multiple inlets into the rotor/stator unit,
(4) continuously dispersing the organic-based phase (I) and aqueous phase (II) in the rotor-stator unit, thereby producing an aqueous polyurethane-based dispersion,
(5) continuously discharging the aqueous polyurethane-based dispersion from the high shear dispersion device, thereby creating a volume flow of the dispersion, and
(6) feeding at least one chain extension agent to the aqueous polyurethane-based dispersion, thereby producing the aqueous polyurethane-polyurea dispersion,
wherein a neutralization step with at least one alkali metal hydroxide as a neutralization agent is conducted during the dispersing process according to steps (3) and (4) above.

6. The process according to claim 5, wherein two neutralization steps with at least one alkali metal hydroxide as the neutralizing agent are conducted, wherein the first neutralization step is conducted during the dispersing process according to steps (3) and (4) and the second neutralization step is conducted after the dispersing process according to step (3) and (4), wherein the degree of neutralization realized during the first step is from 50 to 70% and the degree of neutralization realized in the second step is from above 70 to 95% (as a sum of the first and second neutralization).

7. The process according to claim 6, wherein the first neutralization step is conducted at a temperature of from 40 to 70 °C and the second neutralization step is conducted at a temperature of from 10 to 30 °C.

8. The process according to claim 5, wherein the chain extension agent is selected from the group consisting of aliphatic, aromatic, and araliphatic (mixed aliphatic-aromatic) polyamines comprising at least two primary and/or secondary amino groups.

9. The process according to claim 5, wherein the duration between the point in time at which the dispersion is leaving the high shear dispersion device and the point in time of feeding the chain extension agent is not more than 30 seconds.

10. The process according to claim 5, wherein the polyurethane-polyurea particles in the produced aqueous polyurethane-polyurea dispersion are characterized by a gel fraction of least 70%.

11. An aqueous basecoat composition comprising a pigment and the aqueous polyurethane-polyurea dispersion according to claim 1.

12. The aqueous basecoat composition according to claim 11, further comprising a melamine resin and at least one hydroxy-functional polymer which is different from the polymer present in the aqueous dispersion.

13. A method for producing a multicoat paint system, comprising
(1) applying an aqueous basecoat composition to a substrate,
(2) forming a polymer film from the aqueous basecoat composition applied in stage (1),
(3) applying a clearcoat material to the resulting basecoat film, and subsequently
(4) curing the basecoat film together with the clearcoat film,
wherein the aqueous basecoat material used in stage (1) is a basecoat composition as claimed in claim 11.

14. A multicoat paint system produced by the method as claimed in claim 13.

15. An aqueous basecoat composition comprising a pigment and the aqueous polyurethane-polyurea dispersion according to claim 5.

16. The process according to claim 5, wherein the chain extension agent is selected from the group consisting of aliphatic, aromatic, and araliphatic (mixed aliphatic-aromatic) polyamines comprising triamines having a total of three amino groups selected from primary and secondary amino groups.

17. A method for producing a multicoat paint system, comprising
(1) applying an aqueous basecoat composition to a substrate,
(2) forming a polymer film from the aqueous basecoat composition applied in stage (1),
(3) applying a clearcoat material to the resulting basecoat film, and subsequently
(4) curing the basecoat film together with the clearcoat film,
wherein the aqueous basecoat material used in stage (1) is a basecoat composition as claimed in claim 12.
